(19) United States
(12) Patent Application Publication
(10) Pub. No.: US 2017/0150139 A1
(43) Pub. Date: May 25, 2017

(54) ELECTRONIC DEVICE AND METHOD FOR DISPLAYING CONTENT ACCORDING TO DISPLAY MODE

(71) Applicant: SAMSUNG ELECTRONICS CO., LTD., Suwon-si (KR)

(72) Inventors: Jung-Eun LEE, Suwon-si (KR); Jin-Gil YANG, Suwon-si (KR); Yo-Han LEE, Seongnam-si (KR); Jae-Bong CHUN, Suwon-si (KR)

(21) Appl. No.: 15/361,225

(22) Filed: Nov. 25, 2016

(30) Foreign Application Priority Data
Nov. 24, 2015 (KR) 10-2015-0164990

(51) Int. Cl. H04N 13/04

(52) U.S. Cl. CPC H04N 13/0497; H04N 13/0454; H04N 2013/0096

(57) ABSTRACT

Disclosed are an electronic device and a method for displaying a content screen based on a display mode. A method performed by an electronic device including a processor may include: identifying an attribute of content of a 2D format to be provided by an electronic device by the electronic device including a processor; providing a first content of a first virtual reality format corresponding to the content using the processor when the attribute is a first attribute; and providing a second content of a second virtual reality format corresponding to the content by using the processor when the attribute is a second attribute.

### CROSS-REFERENCE TO RELATED APPLICATION

This application is based on and claims priority under 35 U.S.C. §119 to Korean Application Serial No. 10-2015-0164990, which was filed in the Korean Intellectual Property Office on Nov. 24, 2015, the disclosure of which is incorporated by reference herein in its entirety.

### TECHNICAL FIELD

The present disclosure relates generally to an electronic device, for example, displaying content based on a display mode.

### BACKGROUND

Recently, various electronic devices which can be directly worn on the user's body are developed. Such devices are generally referred to as wearable devices. The wearable devices may be, for example, a Head-Mounted Display (HMD), smart glasses, a smart watch, a smart wristband, a contact lens type device, a ring type device, a shoe type device, a garment type device, and a glove type device, and may have various forms which can be attached to or detached from a human body part or clothes. The wearable device may be directly worn on the body and improve portability and user accessibility.

Among the devices, the Head Mounted Device (HMD) is an electronic device in the form of glasses or a helmet and may include a display unit and a lens. When the user wears the HMD, the display unit is disposed to correspond to locations of the user's eyes and thus the HMD may provide a supersized screen to the user. The provided screen of the HMD moves along with the user's movement, so that the HMD is useful to provide a realistic virtual reality environment. For a large screen of the display unit of the HMD, the lens is interposed between the user's eyes and the display unit and the user may receive an image through the lens.

As described above, conventionally, the user may wear the HMD and receive a virtual reality environment.

However, when the user using a mobile terminal wears the HMD, the user must perform an additional operation to receive the virtual reality environment. As a result, a flow of content which the user is viewing may be interrupted.

### SUMMARY

An electronic device and a method according to various example embodiments may conveniently provide content of a virtual reality format corresponding to a provided content based on activation of a virtual reality mode.

Various example embodiments of the present disclosure provide an electronic device and a method for displaying a content screen based on a display mode.

According to various example embodiments of the present disclosure to achieve the above description, a method performed by an electronic device including a processor includes: identifying, by the electronic device including a processor, an attribute of content of a 2D format to be provided by an electronic device; when the attribute is a first attribute, providing a first content of a first virtual reality format corresponding to the content using the processor; and when the attribute is a second attribute, providing a second content of a second virtual reality format corresponding to the content using the processor.

According to various example embodiments of the present disclosure to achieve the above description, an electronic device includes: a memory that stores content of a 2D format; and a processor, wherein the processor is configured to identify an attribute or situation information of the content of the 2D format to be provided by the electronic device, to provide a first content of a first virtual reality format corresponding to the content when the attribute or the situation information is a first attribute or first situation information, and to provide a second content of a second virtual reality format corresponding to the content when the attribute or the situation information is a second attribute or second situation information.

According to various example embodiments of the present disclosure, an electronic device may conveniently provide content of a virtual reality format corresponding to a provided content based on activation of a virtual reality mode.

According to various example embodiments of the present disclosure, a user may receive a seamless and immersive virtual reality environment of a provided content.

### BRIEF DESCRIPTION OF THE DRAWINGS

The above and other aspects, features, and advantages of the present disclosure will be more apparent from the following detailed description, taken in conjunction with the accompanying drawings, in which like reference numerals refer to like elements, and wherein:

FIG. 1 is a diagram illustrating an example network environment including an electronic device, according to various example embodiments of the present disclosure;

FIG. 2 is a block diagram illustrating an example electronic device according to various example embodiments;

FIG. 3 is a block diagram illustrating an example programming module according to various example embodiments;

FIGS. 4A, 4B and FIG. 5A, 5B are diagrams illustrating examples of a system for providing a virtual reality service according to various example embodiments;

FIGS. 6A and 6B are flowcharts illustrating an example operation for providing a virtual reality content according to various example embodiments;

FIG. 7 is a flowchart illustrating an example operation for providing a virtual reality content according to various example embodiments;

FIG. 8 is a flowchart illustrating an example operation for displaying content of a virtual reality format for a single content according to various example embodiments;

FIG. 9 is a flowchart illustrating an example operation for displaying content of a virtual reality format for one or more contents according to various example embodiments;

FIG. 10 is a flowchart illustrating an example operation for displaying content of a virtual reality format using a virtual reality content corresponding to a provided content or a virtual reality application according to various example embodiments;

FIG. 11 is a flowchart illustrating an example operation for displaying content of a virtual reality format when a multitasking function is performed according to various example embodiments;

FIGS. 12A and 12B are diagrams illustrating examples of an operation of detecting activation of a virtual reality mode according to various example embodiments;

FIGS. 13 and 14 are diagrams illustrating examples of an example attribute related to displaying content according to various example embodiments;

FIGS. 15A and 15B are diagrams illustrating examples of an example situation information related to displaying content according to various example embodiments;

FIGS. 16A, 16B, 16C and FIGS. 17A, 17B and 17C are diagrams illustrating examples of an example content display method according to various example embodiments;

FIGS. 18A, 18B, FIGS. 19A, 19B, FIGS. 20A and 20B are diagrams illustrating examples of an example process of displaying content of a virtual reality format for content according to an example content display method according to various example embodiments;

FIG. 21 is a diagram an example of an example process of displaying content of a virtual reality format when a multitasking function is performed according to various example embodiments; and

FIG. 22 is a diagram illustrating an example of an example process for displaying content of a virtual reality format in a system including a first electronic device, a second electronic device, and a server according to various example embodiments.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

Throughout the description, the expressions “A or B,” “at least one of A or/and B,” “one or more of A or/and B,” and the like may include all combinations of the listed items. For example, “A or B,” “at least one of A and B,” or “at least one of A or B” may refer to all cases of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. The above-described expressions may be used to distinguish an element from another element. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured (or set) to”, used in this disclosure, may be interchangeably used with, for example, “suitable for,” “having the capacity to,” “designed to,” “adapted to,” “made to,” or “capable of” according to circumstances. The term “configured (or set) to” may not necessarily mean “specifically designed to” in hardware. Instead, in some cases, the expression “device configured to” may refer, for example, to the situation in which the device “can ˜” together with other devices or components. For example, the phrase “processor adapted (or configured) to perform A, B, and C” may refer, for example, to a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and may not be intended to limit the scope of other embodiments. As used herein, singular forms may include plural forms as well unless the context clearly indicates otherwise. Unless defined otherwise, all terms used herein, including technical terms and scientific terms, may have the same meaning as commonly understood by a person of ordinary skill in the art to which the present disclosure pertains. Terms, such as those defined in commonly used dictionaries, should be interpreted as having a meaning that is the same or similar to their meaning in the context of the relevant art and will not be interpreted in an idealized or overly formal sense unless expressly so defined herein. In some cases, even the term defined in the present disclosure should not be interpreted to exclude embodiments of the present disclosure.

Electronic devices, according to various embodiments of the present disclosure, may include, for example, at least one of a smart phone, a tablet Personal Computer (PC), a mobile phone, a video phone, an e-book reader, a desktop Personal Computer (PC), a laptop Personal Computer (PC), a netbook computer, a workstation, a server, a Personal Digital Assistant (PDA), a Portable Multimedia Player (PMP), an MP3 player, a mobile medical appliance, a camera, and a wearable device (e.g., smart glasses, a Head-Mounted Device (HMD), electronic clothing, an electronic bracelet, an electronic necklace, an electronic appcessory, electronic tattoos, a smart mirror, or a smart watch), or the like, but is not limited thereto.

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like, but is not limited thereto.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. In various embodiments, the electronic device may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

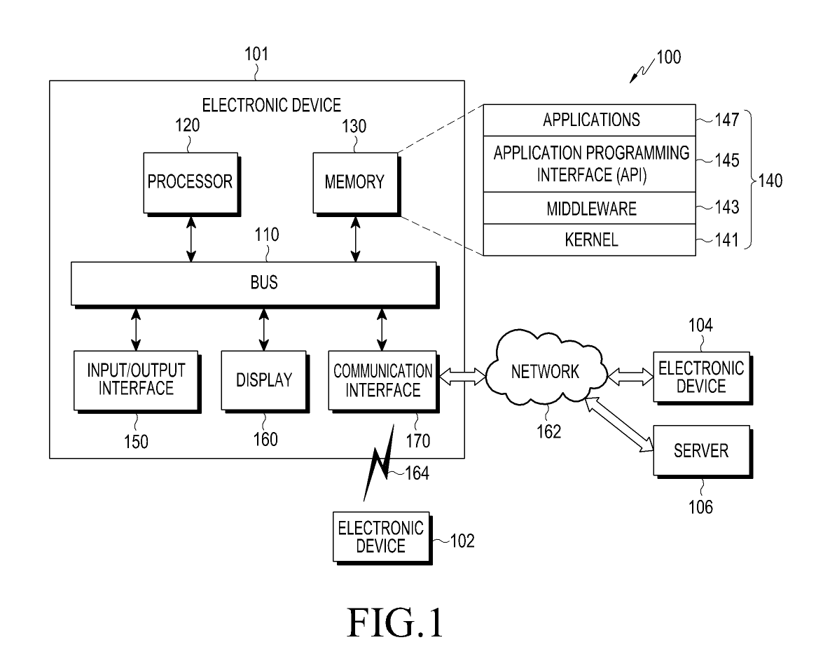

An electronic device 101 in a network environment 100 according to various embodiments will be described with reference to FIG. 1. The electronic device 101 may include a bus 110, a processor 120, a memory 130, an input/output interface (e.g., including input/output circuitry) 150, a display 160, and/or a communication interface (e.g., including communication circuitry) 170. In some embodiments, at least one of the elements of the electronic device 101 may be omitted, or other elements may be additionally included in the electronic device 101.

The bus 110 may include, for example, a circuit for connecting the elements 120 to 170 and transmitting communication (for example, control messages and/or data) between the elements.

The processor 120 may include one or more of a Central Processing Unit (CPU), an Application Processor (AP), and a Communication Processor (CP). For example, the processor 120 may carry out operations or data processing relating to the control and/or communication of at least one other element of the electronic device 101.

According to an embodiment, the processor 120 may identify an attribute of content of a two dimensional format to be provided in the electronic device 101, provide a first content of a first virtual reality format (for example, content of which a format is changed from the 2D format to the virtual reality format) corresponding to the content of the 2D format when the identified attribute is a first attribute, and provide a second content of a second virtual reality format (for example, content generated by combining the content of the 2D format and another content or another content associated with the content of the 2D format) corresponding to the content of the 2D format when the identified attribute is a second attribute. The attribute may include, for example, a genre of the content, an extension, and display information included in the content.

The processor 120 may identify objects (for example, a street view icon, a virtual reality icon, or traffic information) included in the content (for example, a map of the 2D format) and determine a virtual reality content corresponding to the identified object as at least a part of a corresponding content between a first content (for example, a map of a 3D format) and a second content (for example, a street view of a 3D format or traffic information).

The processor 120 may change the 2D format of the content (for example, a video of the 2D format) into a corresponding virtual reality format between a first virtual reality format (for example, a format for changing the video of the 2D format into a video of a 3D format) and a second virtual reality format (for example, a format for changing the video of the 2D format into a virtual reality as if watched in a movie theater).

When the electronic device 101 provides another content (for example, a messenger window), the processor 120 may provide a third content of a third virtual reality format (a format for a change into a virtual reality as if the messenger window is shown in a 3D space) corresponding to the other provided content at least temporarily simultaneously with a corresponding content between the first content and the second content.

The processor 120 may provide the corresponding content between the first content and the second content through a display (or a screen generated through a projector) included in an external electronic device 104 (for example, a TV or projector) functionally connected (through wired or wireless communication) to the electronic device 101.

For example, when the content of the 2D format is a 2D map, the processor 120 may identify an attribute of the 2D map. When the 2D map is a 2D map which can be rendered in three dimensions, the processor 120 may display a 3D map of the virtual reality format on the display 160 through the 3D rendering.

For example, when the 2D map includes a street view type map of a particular region, the processor 120 may display a map of the virtual reality format in the street view type for the particular region on the display 160.

For example, when the content of the 2D format is a 2D movie, the processor 120 may identify an attribute of the 2D movie. When there is a virtual reality application set to implement a virtual reality that shows the 2D movie in a movie theater, the processor 120 may execute the corresponding virtual reality application and display an execution of the virtual reality application of the virtual reality format on the display 160.

For example, a 2D movie which can be provided (reproduced) by a first screen size (for example, 320×240 pixels) and a second screen size (for example, 1920×1080 pixels) larger than the first screen size may be stored in the memory 130 of the electronic device 101 or the server 106 functionally connected to the electronic device 101. In this case, the processor 120 may display the 2D movie in the second screen size corresponding to the virtual reality format of the 2D movie through the external electronic device 104 functionally connected to the electronic device 101. Further, for example, when the electronic device 101 is not connected to the external electronic device 104, the processor 120 may display the 2D movie in the first screen size of the 2D format on the display 160 included in the electronic device 101.

For example, when an image of a 3D format for a 2D movie is stored in the memory 130 of the electronic device 101 or the external server 106 through a connection with a file of the 2D movie, the processor 120 may display the image of the 3D format for the 2D movie as content of a virtual reality format for the 2D movie through the display 160. Further, when the image of the 3D format for the 2D movie is not stored in the memory 130 of the electronic device 101 or the external server 106 through the connection with the file of the 2D movie, the processor 120 may generate a virtual reality for a movie theater as the content of the virtual reality format for the 2D movie. The processor 120 may display a screen for a movie theater in the virtual reality format through the display 160 such that the 2D movie is provided (for example, reproduced) through the virtual reality for the movie theater.

According to various embodiments, when a virtual reality mode for implementing a virtual reality environment is activated, the processor 120 may perform the above described operations.

According to an embodiment, the processor may identify an attribute (for example, a link of content, display information of a relevant application or file, and metadata) for the content of the 2D format to be provided by the electronic device 101 or situation information (for example, execution information (for example, whether to execute multitasking, a multi-window, and a popup window), user input information, and a current location). When the identified attribute or situation information corresponds to a first attribute (for example, relevant link) or first situation information (for example, multi-window), the processor may provide a first content of a first virtual reality format (for example, content of a virtual reality format connected to the link or content of a format for a change into a virtual reality as if the multiple windows are arranged and shown in a 3D space) corresponding to the content of the 2D format. When the identified attribute or situation information corresponds to a second attribute (for example, relevant application) or second situation information (for example, popup window), the processor may provide a second content of a second virtual reality format (for example, an application execution screen of the virtual reality format or content for a change into a virtual reality as if the popup window is shown in a 3D space) corresponding to the content of the 2D format. The situation information may include first situation information on a situation (for example, a situation in which a map and a messenger are executed together) in which the electronic device 101 executes another content (or application) as well as the content of the 2D format and second situation information on a situation (for example, a situation in which only the map is executed) in which the electronic device 101 provides only one content.

For example, when the identified attribute corresponds to the first situation information, the processor 120 may display a virtual reality content including the content of the 2D format and the other content.

For example, when the identified attribute corresponds to the second situation information, the processor 120 may display a virtual reality content for the content of the 2D format.

According to an embodiment, when a first display mode (for example, a mode in which the content of the 2D format is provided) is changed into a second display mode (for example, a virtual reality mode or a mode in which content of the virtual reality format is provided) while at least one content is provided, the processor 120 may acquire content information of the provided content, determine a content display method based on the acquired content information, and display a content providing screen according to the second display mode based on the determined content display method. The first display mode may be an operation for configuring and displaying a screen for providing various contents (for example, applications, voice calls, media, messages, and emails) in the electronic device 101. The second display mode may be an operation for displaying virtual reality contents for various contents being provided. The content information may include an attribute and situation information for the content.

The attribute may include a link of the content, display information of a relevant application or file, and metadata, and the situation information may include execution information (for example, whether to execute multitasking, a multi-window, and a popup window) of the electronic device 101 that provides the content, user input information, and a current location.

The content display method may include, for example, a first display method of reproducing and displaying a virtual reality content, a second display method of combining the virtual reality content with an additional content and reproducing and displaying the combined content, a third display method of generating and displaying a virtual reality content that shows at least one 2D content in a 3D virtual space, a fourth display method of executing an application that provides a virtual reality service and displaying an execution screen of a virtual reality format, a fifth display method of extending and displaying a window size or a screen size in which the content is displayed, or a combination thereof.

According to an embodiment, the first display method includes a 3D display method that shows a stereoscopic space. The third display method includes, for example, a 360 degree panorama image or video display method and a 3D application display method. According to an embodiment, the second display method may include an Augmented Reality (AR) display method that combines reality and a virtual space and shows the combined reality and virtual space. The AR display method may include, for example, a method of displaying a menu, a control panel, or additional information in addition to the 3D display content. According to an embodiment, the third display method may include a display method of generating and displaying a virtual reality content as if a 2D content is shown within a 3D virtual space. According to an embodiment, the fourth display method may include a method of displaying a 2D or 3D content in some of a virtual reality application execution screen by using a virtual reality application. According to an embodiment, the fifth display method may include an extended screen display method that extends and displays a window size of the content.

For example, when the second display mode for displaying content of a virtual reality format for a 2D map is executed while a screen that provides the 2D map is displayed, the processor 120 may determine whether the 2D map may display a virtual reality content by identifying content information of the 2D map.

For example, when there is a 3D map corresponding to the 2D map, the processor 120 may determine the 2D map as the content of the virtual reality format. The 3D map corresponding to the 2D map may be displayed through the display 160 according to the first display method. When the 2D map is rendered in three dimensions, the processor 120 may render the 2D map in three dimensions and display the map through the display 160.

For example, when the 2D map, which can be rendered in three dimensions, includes an additional content (for example, traffic information), the processor 120 may render the 2D map in three dimensions according to the second display method, arrange a popup window showing traffic information at a currently displayed location of the rendered 3D map, and display the popup window through the display 160.

For example, when the 2D map is not the virtual reality content, the processor 120 may generate a virtual reality content as if the 2D map is shown in a partial area within the virtual space and displayed through the display 160 according to the third display method.

For example, when there is a virtual reality application that provides a virtual reality service related to the 2D map, the processor 120 may execute a virtual reality application and display an application execution screen of the virtual reality format through the display 160 according to the fourth display method.

For example, when there is a 2D map in an extended window size related to the 2D map, the processor 120 may display the 2D map in the extended window size through the display 160 according to the fifth display method. When the 2D map includes regions in Seoul, the processor 120 may display regions in Gyeonggi-do as well as Seoul through the display 160 as the line of sight widens.

According to an embodiment, when there is a 2D map in an extended screen size related to the 2D map, the processor 120 may display the 2D map in the extended screen size through the display 160. When the 2D map includes regions in Seoul, the processor 120 may enlarge the regions in Seoul and display the enlarged regions through the display 160.

The memory 130 may include a volatile memory and/or a non-volatile memory. The memory 130 may store, for example, instructions or data relating to at least one other element of the electronic device 101. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middle 143, and the API 145 may be referred to as an Operating System (OS).

According to an embodiment, the memory 130 may store various types of data used for providing content by the processor 120 in a virtual reality mode.

For example, the kernel 141 may control or manage the system resources (for example, the bus 110, the processor 120, the memory 130, and the like) that are used to execute operations or functions implemented in the other programs (for example, the middleware 143, the API 145, and the application programs 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data. Further, in relation to requests for an operation received from the application program 147, the middleware 143 may control (for example, scheduling or load-balancing) the requests for the operation using, for example, a method of determining a sequence for using system resources (for example, the bus 110, the processor 120, the memory 130, or the like) of the electronic device 101 with respect to at least one application of the application program 147.

The API 145 is an interface by which the applications 147 control functions provided from the kernel 141 or the middleware 143, and may include, for example, at least one interface or function (for example, instructions) for file control, window control, image processing, or text control.

The input/output interface 150 may various input/output circuitry configured to function as, for example, an interface that can forward instructions or data, which are input from a user or another external device, to the other element(s) of the electronic device 101. Furthermore, the input/output interface 150 may output the instructions or data received from the other element(s) of the electronic device 101 to the user or another external device. According to an embodiment, the input/output interface 150 may transfer an input for changing a first display mode into a second display mode to the processor 120. According to an embodiment, the input/output interface 150 may transfer an input for activating a virtual reality mode to the processor 120.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display various types of contents (for example, text, images, videos, icons, or symbols) to users. The display 160 may include a touch screen and may receive, for example, a touch, gesture, proximity, or hovering input using an electronic pen or the user's body part. According to an embodiment, the display 160 may display a content providing screen according to the first display mode (for example, 2D content providing mode). According to an embodiment, the display 160 may display the content providing screen according to the second display mode (for example, virtual reality mode).

The communication interface 170 may include various communication circuitry configured to provide communication, for example, between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may include, for example, at least one of LTE, LTE-A, CDMA, WCDMA, UMTS, WiBro, and GSM as a cellular communication protocol implemented via a wireless connection 164. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a communication network such as a computer network (for example, a LAN or a WAN), the Internet, and a telephone network.

Each of the first and second external electronic devices 102 and 104 may be of the same or a different type from the electronic device 101. According to an embodiment, the server 106 may include a group of one or more servers.

According to various embodiments, all or some of the operations performed in the electronic device 101 may be performed in another electronic device or a plurality of electronic devices (for example, the electronic devices 102 and 104 or the server 106). According to an embodiment, when the electronic device 101 has to perform a function or service automatically or in response to a request, the electronic device 101 may request another device (for example, the electronic device 102 or 104, or the server 106) to perform at least some functions relating thereto, instead of autonomously or additionally performing the function or service. The other electronic device (for example, the electronic device 102 or 104 or the server 106) may perform the requested functions or the additional functions and may transfer the execution result to the electronic device 101. The electronic device 101 may provide the received result as it is, or may additionally process the received result to provide the requested functions or services. To this end, for example, cloud computing, distributed computing, or client-server computing technology may be used.

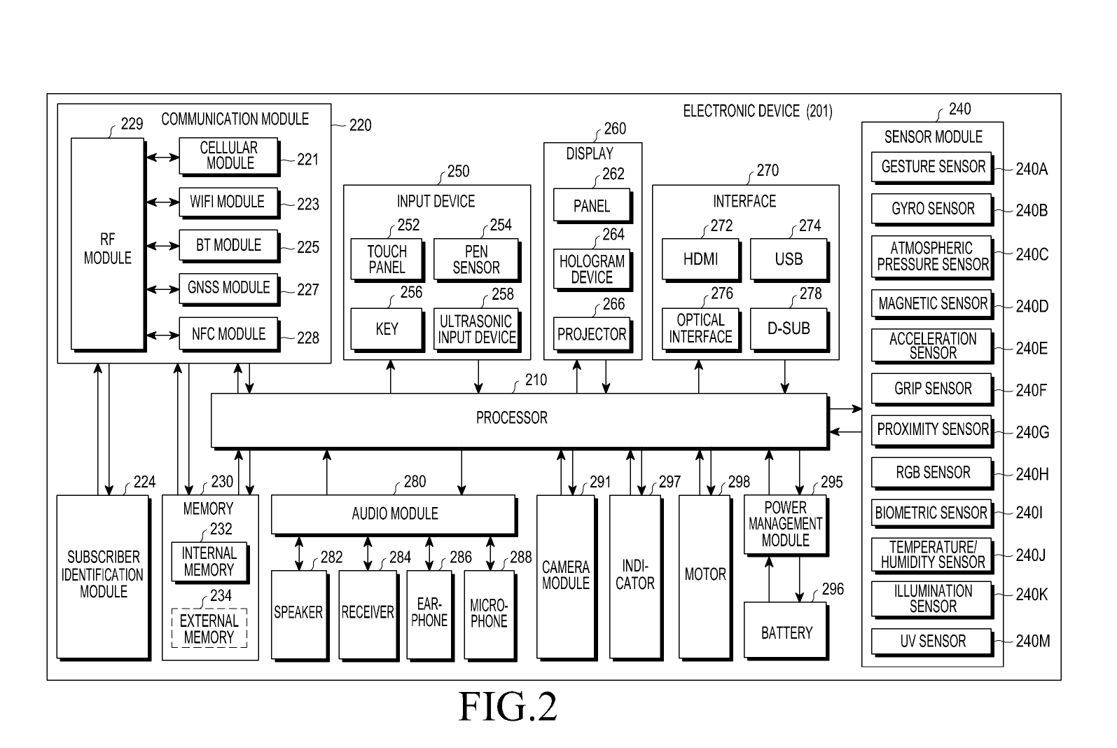

FIG. 2 is a block diagram 200 illustrating an example electronic device 201 according to various example embodiments. The electronic device 201 may include, for example, the entirety or a part of the electronic device 101 illustrated in FIG. 1. The electronic device 201 may include at least one Application Processor (AP) 210, a communication module (e.g., including communication circuitry) 220, a Subscriber Identification Module (SIM) card 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The AP 210 may control a plurality of hardware or software components connected to the processor 210 by driving, for example, an operating system or an application program and perform various types of data processing and calculations. The AP 210 may be embodied as, for example, a System on Chip (SoC). According to an embodiment, the processor 210 may further include a Graphic Processing Unit (GPU) and/or an image signal processor. The AP 210 may include at least some of the elements (for example, a cellular module 221) illustrated in FIG. 2. The processor 210 may load, into a volatile memory, instructions or data received from at least one (for example, a non-volatile memory) of the other elements, process the loaded instructions or data, and store various data in a non-volatile memory.

The communication module 220 may include various communication circuitry and have a configuration that is the same as, or similar to, that of the communication interface 170 illustrated in FIG. 1. The communication module 220 may include various communication circuitry, such as, for example, and without limitation, a cellular module 221, a Wi-Fi module 223, a BT module 225, a GNSS module 227, an NFC module 228, and a Radio Frequency (RF) module 229.

The cellular module 221 may provide, for example, a voice call, a video call, a text message service, an Internet service, and the like through a communication network. According to an embodiment, the cellular module 221 may identify and authenticate the electronic device 201 within a communication network using a subscriber identification module (for example, the SIM card 224). According to an embodiment, the cellular module 221 may perform at least some of the functions, which can be provided by the AP 210. According to an embodiment, the cellular module 221 may include a Communication Processor (CP).

Each of the Wi-Fi module 223, the BT module 225, the GNSS module 227, and the NFC module 228 may include, for example, a processor for processing data transmitted/received through the corresponding module. According to some embodiments, at least some (for example, two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (for example, an RF signal). The RF module 229 may include, for example, a transceiver, a Power Amplifier Module (PAM), a frequency filter, a Low Noise Amplifier (LNA), an antenna, and the like. According to another embodiment, at least one of the cellular module 221, the Wi-Fi module 223, the BT module 225, the GNSS module 227, and the NFC module 228 may transmit/receive an RF signal through a separate RF module.

The Subscriber Identification Module (SIM) 224 may include a card including a subscriber identification module and/or an embedded SIM, and contain unique identification information (for example, an Integrated Circuit Card Identifier (ICCID)) or subscriber information (for example, an International Mobile Subscriber Identity (IMSI)).

The memory 230 (for example, the memory 130 of FIG. 1) may include an internal memory 232 or an external memory 234. The internal memory 232 may include, for example, at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory, a NOR flash memory, and the like), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an extreme Digital (xD), a memory stick or the like. The external memory 234 may be functionally and/or physically connected to the electronic device 201 through various interfaces.

The sensor module 240 may, for example, measure a physical quantity or detect the operating state of the electronic device 201 and may convert the measured or detected information into an electrical signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 240I, a temperature/humidity sensor 240J, an illumination sensor 240K, and an Ultra Violet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, the electronic device 201 may further include a processor, which is configured to control the sensor module 240, as a part of the AP 210 or separately from the AP 210 in order to control the sensor module 240 while the AP 210 is in a sleep state.

The input device 250 may include various input circuitry, such as, for example, and without limitation, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user.

The (digital) pen sensor 254 may include, for example, a recognition sheet which is a part of the touch panel or is separated from the touch panel. The key 256 may include, for example, a physical button, an optical key, or a keypad. The ultrasonic input unit 258 may input data through an input means that generates an ultrasonic signal, and the electronic device 201 identify data by detecting a sound wave with a microphone (for example, a microphone 288).

The display 260 (for example, the display 160) may include a panel 262, a hologram device 264 or a projector 266. The panel 262 may include the same or a similar configuration to the display 160 illustrated in FIG. 1. The panel 262 may be implemented to be, for example, flexible, transparent, or wearable. The panel 262, together with the touch panel 252, may be implemented as one module. The hologram device 264 may show a three-dimensional image in the air using an interference of light. The projector 266 may display an image by projecting light onto a screen. The screen may be located, for example, in the interior of, or on the exterior of, the electronic device 201. According to an embodiment, the display 260 may further include a control circuit for controlling the panel 262, the hologram device 264, or the projector 266.

The interface 270 may include various interface circuitry, such as, for example, and without limitation, a High-Definition Multimedia Interface (HDMI) 272, a Universal Serial Bus (USB) 274, an optical interface 276, or a D-subminiature (D-sub) 278. The interface 270 may be included in, for example, the communication circuit 170 illustrated in FIG. 1. Additionally or alternatively, the interface 270 may, for example, include a mobile high-definition link (MHL) interface, a secure digital (SD) card/multi-media card (MMC) interface, or an infrared data association (IrDA) standard interface.

The audio module 280 may, for example, convert a sound into an electrical signal, and vice versa. At least some elements of the audio module 280 may be included, for example, in the input/output interface 150 illustrated in FIG. 1. The audio module 280 may process sound information that is input or output through, for example, a speaker 282, a receiver 284, earphones 286, the microphone 288, and the like.

The camera module 291 may take, for example, a still image or a moving image, and according to one embodiment, the camera module 291 may include one or more image sensors (for example, a front sensor or a rear sensor), a lens, an Image Signal Processor (ISP), or a flash (for example, an LED or a xenon lamp).

The power management module 295 may manage, for example, the power of the electronic device 201. According to an embodiment, the power management module 295 may include a Power Management Integrated Circuit (PMIC), a charger Integrated Circuit (IC), or a battery 296 or fuel gauge. The PMIC may use a wired and/or wireless charging method. Examples of the wireless charging method may include, for example, a magnetic resonance method, a magnetic induction method, an electromagnetic wave method, and the like. Additional circuits (for example, a coil loop, a resonance circuit, a rectifier, and the like.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a specific state, such as a booting state, a message state, a charging state, of the electronic device 201 or a part of the electronic device 201 (for example, the AP 210). The motor 298 may convert an electrical signal into a mechanical vibration and may generate a vibration, a haptic effect, and the like. Although not illustrated, the electronic apparatus 201 may include a processing unit (for example, a GPU) for supporting mobile TV. The processing unit for supporting mobile TV may process media data according to a standard, for example, Digital Multimedia Broadcasting (DMB), Digital Video Broadcasting (DVB), mediaFlo™, and the like.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

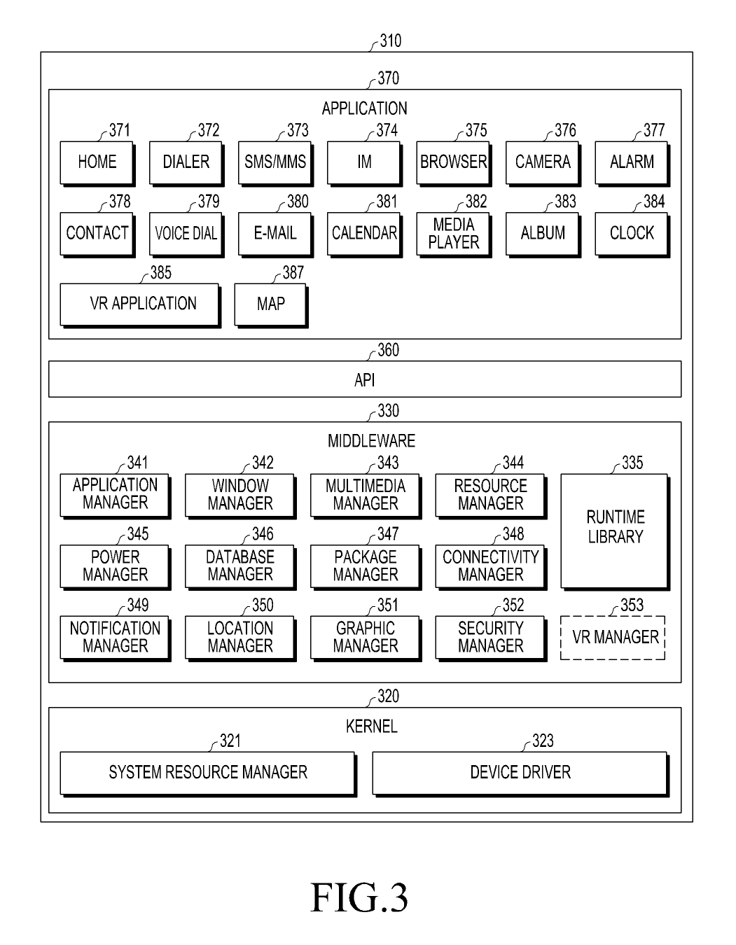

FIG. 3 is a block diagram 300 illustrating an example program module 310 according to various embodiments of the present disclosure. According to an embodiment, the program module 310 (for example, the program 140 of FIG. 1) may include an Operating System (OS) that controls resources relating to an electronic device (for example, the electronic device 101) and/or various applications (for example, the application programs 147) running on the operating system. The operating system may be, for example, Android, iOS, Windows, Symbian, Tizen, Bada, and the like.

The program module 310 may include a kernel 320, middleware 330, an Application Programming Interface (API) 360, and/or applications 370. At least a part of the program module 310 may be preloaded on the electronic device, or may be downloaded from an external electronic device (for example, the electronic device 102 or 104 or the server 106).

The kernel 320 (for example, the kernel 141) may include, for example, a system resource manager 321 and/or a device driver 323. The system resource manager 321 may control, assign, or retrieve system resources. According to an embodiment, the system resource manager 321 may include a process management unit, a memory management unit, or a file system management unit. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function required by the applications 370 in common, or may provide various functions to the applications 370 through the API 360 so that the applications 370 can efficiently use the limited system resources of the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and a virtual reality manager 353.

The runtime library 335 may include, for example, a library module that a compiler uses in order to add a new function through a programming language while the applications 370 are being executed. The runtime library 335 may perform functions that are related to the management of input and output, the management of a memory, an arithmetic function, and the like.

The application manager 341 may manage, for example, a life cycle of at least one of the applications 370. The window manager 342 may manage Graphical User Interface (GUI) resources used on a screen. The multimedia manager 343 may identify formats required for reproducing various media files and may encode or decode a media file using a codec suitable for the corresponding format. The resource manager 344 may manage resources of at least one of the applications 370, such as a source code, a memory, a storage space, and the like.

The power manager 345 may operate together with, for example, a Basic Input/Output System (BIOS) to manage a battery or power and provide power information required for the operation of the electronic device. The database manager 346 may generate, search, or change a database to be used by at least one of the applications 370. The package manager 347 may manage the installation or the updating of an application that is distributed in the form of a package file.

The connectivity manager 348 may manage a wireless connection, for example, Wi-Fi, Bluetooth, and the like. The notification manager 349 may display or notify of an event, such as an arrival message, an appointment, notification of proximity, and the like, in such a manner as not to disturb a user. The location manager 350 may manage location information of the electronic device. The graphic manager 351 may manage a graphic effect to be provided to a user and a user interface relating to the graphic effect. The security manager 352 may provide all security functions required for system security or user authentication. According to an embodiment, the graphic manager 351 may manage a screen configuration according to a change in the display mode. For example, when the first display mode is changed into the second display mode, the graphic manager 351 may generate an HMD frame including a left eye image of a left eye view and a right eye image of a right eye view.

The virtual reality manager 353 may manage a virtual reality mode function for providing content of a virtual reality format for the content and reproduction of a virtual reality content. According to various embodiments, the virtual reality manager 353 may be selectively included, and the graphic manager 351 may perform the operation of the virtual reality manager 353.

According to various embodiments, when the electronic device (for example, the electronic device 101) has a telephone call function, the middleware 330 may further include a telephony manager that manages a voice or video call function of the electronic device.

The middleware 330 may include a middleware module that forms combinations of the various functions of the above-described elements. The middleware 330 may provide specialized modules according to the types of operating systems in order to provide differentiated functions. Furthermore, the middleware 330 may dynamically remove some of the existing elements, or may add new elements.

The API 360 (for example, the API 145) is, for example, a set of API programming functions, and may be provided with different configurations according to operating systems. For example, in the case of Android or iOS, one API set may be provided for each platform, and in the case of Tizen, two or more API sets may be provided for each platform.

The applications 370 (for example, the application programs 147) may include one or more applications that can perform functions, for example, home 371, dialer 372, SMS/MMS 373, Instant Message (IM) 374, browser 375, camera 376, alarm 377, contact(s) 378, voice dial 379, e-mail 380, calendar 381, media player 382, album 383, clock 384, VR application 385, map 387, health care (for example, measuring exercise quantity or blood sugar), and environment information (for example, atmospheric pressure, humidity, temperature information, and the like).

According to an embodiment, the VR application 385 may be an application that provides a virtual reality content. The VR application 385 may be, for example, an application that provides a virtual reality providing a movie in a movie theater.

According to an embodiment, the VR application 385 may be, for example, an application that generates a virtual reality content. For example, the VR application 385 may generate a left eye image corresponding to a user's left eye and a right image corresponding to a user's right eye by using one image. The VR application 385 may display the left eye image in a left area of the display and the right eye image in a right area of the display. Accordingly, the user may watch the left image through the user's left eye and the right image through the user's right eye. Therefore, the user may feel the image in three dimensions through a combination of the left eye image and the right eye image.

According to various embodiments, the applications 370 may include an application (hereinafter, referred to as an “information exchange application” for convenience of description) that supports information exchange between the electronic device (for example, the electronic device 101) and an external electronic device (for example, the electronic device 102 or 104). The information exchange application may include, for example, a notification relay application for forwarding particular information to an external electronic device or a device management application for managing an external electronic device.

For example, the notification relay application may include a function of transferring, to the external electronic device (for example, the electronic device 102 or 104), notification information that is generated from the other applications (for example, the SMS/MMS application, the e-mail application, the health care application, the environmental information application, and the like) of the electronic device. Furthermore, the notification relay application, for example, may receive notification information from an external electronic device and may provide the received notification information to a user.

The device management application may manage (for example, install, delete, or update), for example, at least one function of an external electronic device (for example, the electronic device 102 or 104) that communicates with the electronic device (for example, a function of turning on/off the external electronic device itself (or some components thereof) or a function of adjusting the brightness (or resolution) of a display), applications that operate in the external electronic device, or services (for example, a call service, a message service, and the like) that are provided by the external electronic device.

According to various embodiments, the applications 370 may include an application (for example, health care application of a mobile medical device) stored according to an attribute of an external electronic device (for example, the electronic device 102 or the electronic device 104). According to an embodiment, the applications 370 may include applications received from an external electronic device (for example, the server 106 or the electronic device 102 or 104). According to an embodiment, the applications 370 may include a preloaded application or a third party application that may be downloaded from a server. The names of the elements of the program module 310, according to the embodiment illustrated in the drawing, may vary according to the type of operating system.

According to various embodiments, at least a part of the programming module 310 may be implemented in software, firmware, hardware, or a combination of two or more thereof. At least some of the program module 310 may be implemented (for example, executed) by, for example, the processor (for example, the processor 210). At least a part of the program module 310 may include, for example, a module, a program, a routine, a set of instructions, a process, and the like for performing one or more functions.

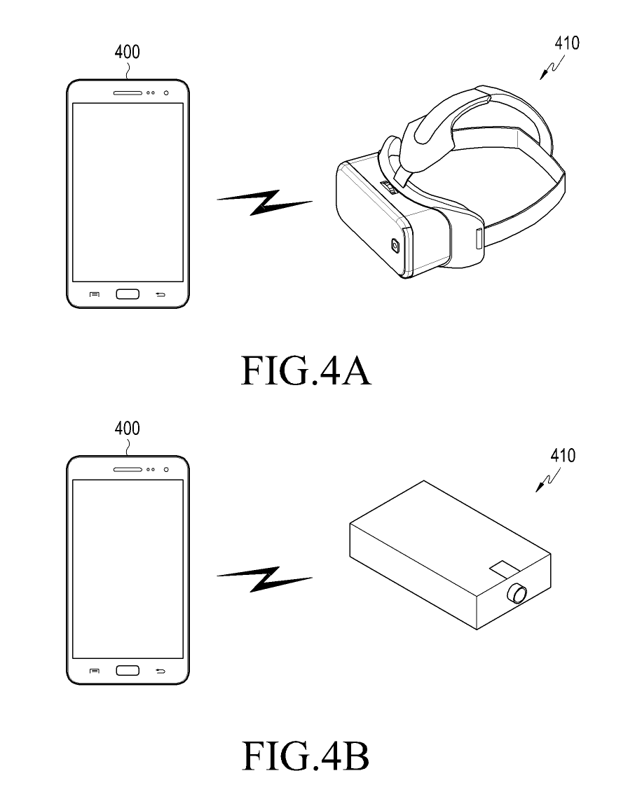

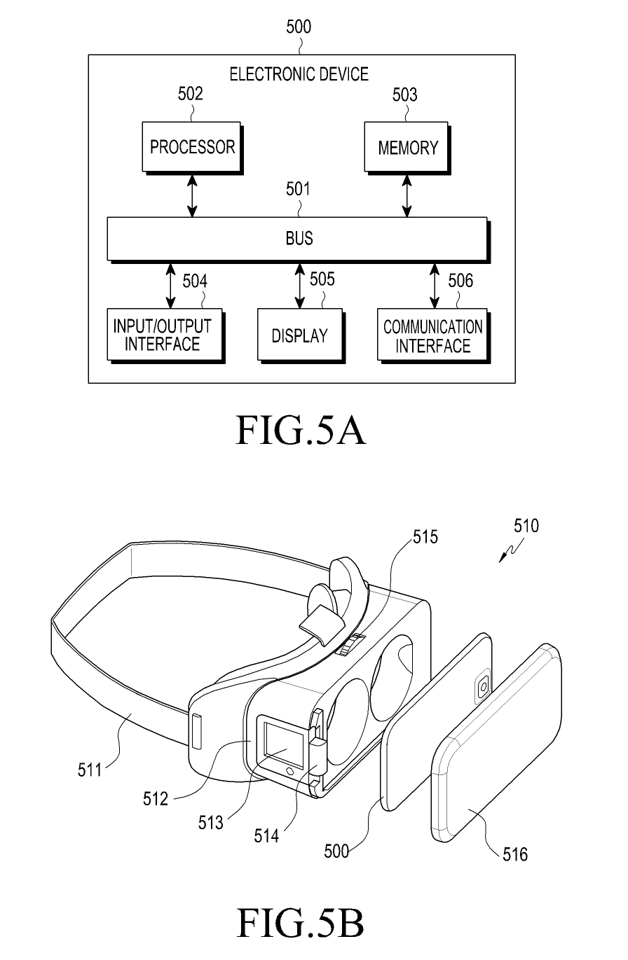

FIGS. 4A, 4B and FIG. 5A, 5B are diagrams illustrating examples of a system for providing a virtual reality service according to various example embodiments.

According to FIG. 4A, the system according to the present disclosure may include a first electronic device 400 and a second electronic device 410. The first electronic device 400 may include, for example, and without limitation, a mobile terminal, and the second electronic device 410 may include, for example, and without limitation, a Head Mounted Display (HMD). For example, the second electronic device 410 may include an HMD electrically connected to the mobile terminal.

According to FIG. 4B, the second electronic device 410 may include, for example, and without limitation, a display device or a projector. According to various embodiments of the present disclosure, the first electronic device 400 and the second electronic device 410 are not limited to the above described electronic devices. For example, the first electronic device 400 may include home appliances, furniture, or medical devices. Further, for example, the second electronic device 410 may include home appliances, furniture, or medical devices having a display or a projector.

According to an embodiment, the first electronic device 400 may provide content in a first display mode (for example, a mode for providing content in a 2D format) and the second electronic device 410 may provide content in a second display mode (for example, a virtual environment mode). According to an embodiment, when the first electronic device 400 and the second electronic device 410 are connected (for example, through wired or wireless communication or physically) while the first electronic device 400 provides the content in the first display mode, the first electronic device 400 may activate the second display mode. According to an embodiment, the first electronic device 400 may display the content of the 2D format through the display (the display of the electronic device 400) functionally connected to the first electronic device 400 in the first display mode.

For example, the first electronic device 400 is functionally connected to the second electronic device 410 corresponding to an external electronic device which can be mounted on the user's head and may determine that the virtual reality mode is activated at least partially based on the use of the second electronic device 410. For example, the first electronic device 400 may determine that the virtual reality mode is activated at least partially based on the functional connection (for example, a connection through wired or wireless communication or a physical connection) with the second electronic device 410 corresponding to an external electronic device such as a display or a projector.

According to an embodiment, when the second display module (for example, virtual reality mode) is activated, the first electronic device 400 may acquire information on a provided content, determine a content display method based on the acquired content information, configure a content providing screen according to the second display mode based on the determined content display method, and transfer the content providing screen to the second electronic device 410. The second electronic device 410 may display the content providing screen received from the first electronic device 400.

According to an embodiment, when the second display mode is activated, the second electronic device 410 may acquire information on content provided by the first electronic device 400, determine a content display method based on the acquired content information, and configure and display a content providing screen according to the second display mode based on the determined content display method.

According to FIGS. 5A and 5B, the system of the present disclosure may include a third electronic device 500 (for example, the electronic device 101 or 201 or the first electronic device 400) and a fourth electronic device 510 (for example, the electronic device 101, 201, or 104, or the second electronic device 410). According to an embodiment, the third electronic device 500 may be combined with the fourth electronic device 510. For example, the third electronic device 500 may include a mobile terminal, and the fourth electronic device 510 may include a head mounted device coupled to the mobile terminal.

Referring to FIG. 5A, the third electronic device 500 may include a bus 501, a processor 502 (for example, the processor 120 or 210, the program module 310, the VR application 385, the graphic manager 351, or the VR manager 353), a memory 503, an input/output interface (e.g., including input/output circuitry) 504, a display 505, and a communication interface (e.g., including communication circuitry) 506. According to various embodiments, although not illustrated, at least one of the bus 501, the processor 502, the memory 503, the input/output interface 504, the display 505, and the communication interface 506 may be included in another electronic device functionally connected to the electronic device 500. According to an embodiment, each element of the third electronic device 500 may perform an operation equal or similar to that of each element of the electronic device 101 described in FIG. 1. According to an embodiment, the third electronic device 500 may provide content of a 2D format in the first display mode.

According to an embodiment, the processor 502 may determine whether the third electronic device 500 is combined with the fourth electronic device 510. When the third electronic device 500 is combined with the fourth electronic device 510, the processor 502 may acquire content information (for example, metadata) of content provided (or to be provided) by the third electronic device 500, determine a content display method based on the acquired content information, configure a content providing screen according to the second display mode based on the determined content display method, and display the content providing screen on the display 505.

According to various embodiments, when an event for changing the first display mode into the second display mode is detected, the processor 502 may acquire content information of content provided (or to be provided) and identify an attribute associated with the display of the content or situation information based on the acquired content information. The processor 502 may determine a content display method based on the identified attribute or situation information and display content of the virtual reality format based on the determined content display method. For example, when an event for activating the virtual reality mode is detected while a 2D map is displayed, the processor 502 may acquire content information of the 2D map. The acquired content information may include attributes containing link information related to the 2D map, display information of a relevant application or file, and metadata. The situation information may include execution information of the third electronic device 500 that provides the 2D map, user's input information, and a current location. When a 3D map related to the 2D map exists (or is stored) in the memory 503 of the third electronic device 500 or the external electronic device (for example, the electronic device 104 or the server 106) connected to the third electronic device 500, the processor 502 may display the 3D map corresponding to the 2D map on the display 505.

According to an embodiment, in order to display the content of the virtual reality format, the processor 502 may display a stereoscopic image stored in the memory 503 or generate and display a stereoscopic on the display 505. Further, according to various embodiments, the processor 502 may convert a monoscopic image stored in the memory 503 into a stereoscopic image. The stereoscopic image may include a left eye image and a right eye image, and the left eye image and the right eye image may be, for example, equal or similar images or different images. The 3D image may indicate, for example, an image having a left eye image and a right eye mage different from each other. According to an embodiment, the left eye image and the right eye image may be, for example, actually simultaneously (or at different times) displayed. By a combination of the different left eye image and right eye image displayed at the same time (or different time), the user may three-dimensionally feel the corresponding image.

For example, when the content provided (or to be provided) is a 2D map which can be rendered in three dimensions or when a 3D map related to the 2D map exists in the memory 503 or the external electronic device (for example, the electronic device 104 or the server 106) connected to the electronic device 500, the processor 502 may generate a left eye image and a right eye image for the 3D map and simultaneously display the generated left eye image and right eye image on the display 505.

For example, when the provided content is a 2D map which cannot be rendered in three dimensions or when there is no relevant 3D content (for example, when a 3D map corresponding to the 2D map is not stored in the memory 503 or the external electronic device (for example, the electronic device 104 or the server 106) connected to the electronic device), the processor 502 may generate a left eye image and a right eye image of the virtual reality content showing the 2D map within a virtual space and then actually simultaneously display, for example, the generated left eye image and right eye image on the display 505.

For example, when content provided (or to be provided) by the third electronic device 500 is a 2D movie and when there is a virtual reality application (for example, VR application 385) for the 2D movie (for example, when the virtual reality application is stored in the memory 503 or the external electronic device (for example, the electronic device 104 or the server 106), the processor 502 may execute the virtual reality application to generate a left eye image and a right eye image for an execution screen and, for example, actually simultaneously display the generated left eye image and right eye image on the display 505.

For example, when content provided (to be provided) is a 3D movie, the processor 502 may generate a left eye image and a right eye image for a 3D movie screen and, for example, actually simultaneously display the generated left eye image and right eye image on the display 505.

According to an embodiment, the communication interface 506 may receive (or transmit) a signal transferred from the fourth electronic device 510. For example, when the third electronic device 500 is attached to the fourth electronic device 510 (is connected to the fourth electronic device 510 through wired or wireless communication), the fourth electronic device 510 may transmit, to the third electronic device 500, a signal for informing that the third electronic device 500 is attached to the fourth electronic device 510 (is connected to the fourth electronic device 510 through wired or wireless communication). The communication interface 506 may receive the signal and transfer the signal to the processor 502. Further, for example, the communication interface 506 may receive a signal for informing that the user wears the fourth electronic device 510 to which the third electronic device 500 is attached (or the user uses the fourth electronic device 510) from the fourth electronic device 510 and transfer the signal to the processor 502. According to various embodiments, an electrical signal informing that the third electronic device 500 is attached to the fourth electronic device 510 may be transferred to the communication interface 506 of the third electronic device 500 from the fourth electronic device 510 through short-range wireless communication (for example, short-range communication such as NFC or Bluetooth). According to various embodiments, when the third electronic device 500 is attached to the fourth electronic device 510 (or is connected to the fourth electronic device 510 through wired or wireless communication), a geomagnetic signal for informing that the third electronic device 500 is attached to the fourth electronic device 510 may be generated and the geomagnetic signal may be transferred to the third electronic device 500 from the fourth electronic device 510, and thus the processor 502 may recognize that the third electronic device 500 is attached to the fourth electronic device 510.

According to various embodiments, the processor 502 may detect that the fourth electronic device 510 is mounted to the third electronic device 500 through the communication interface 506. The communication interface 502 may be implemented in the type including, for example, a USB or a socket, and may be connected to the fourth electronic device 510 through the USB or the socket. For example, when the third electronic device 500 and the fourth electronic device 510 are connected to each other, the communication interface 506 may generate an electrical signal for informing that the fourth electronic device 510 is connected to the communication interface 506 and transfer the electrical signal to the processor 506.

Referring to FIG. 5B, the fourth electronic device 510 may include one or more of a mounting part 511, a main frame 512, a touch panel 513, a connector 514, a location adjustor 515, and a cover 516.

According to an embodiment, the mounting part 511 may be connected to the main frame 512 and may fix the fourth electronic device 510 to a user's body part, for example, user's head. According to various embodiments, the mounting part 511 may include a band made by an elastic material and may fit the main frame 512 to the user's eyes on the face. According to various embodiments, the mounting part 511 may include eye glass temples, a helmet, or a strap.

According to an embodiment, the main frame 512 may include a space or a structure for accommodating the third electronic device 500 such that the display device (for example, the third electronic device 500) is attached. Further, according to an embodiment, the connector 514 may be formed at a left end or a right end of the main frame 512 and may be combined to an electrical access unit (for example, USB port) of the third electronic device 500. According to an embodiment, the main frame 512 may be configured to be attached to/detached from the third electronic device 500.

According to an embodiment, the main frame 512 may include at least one of the touch panel 513, the location adjustor 515, and a lens adjustor (not shown) on an external surface of the main frame 512 as a user interface.

According to another embodiment, the main frame 512 may include a control device for controlling the third electronic device 500 on a side surface. The control device may be one or more of, for example, a physical key, a physical button, a touch key, a joystick, a wheel key, and a touch pad. The touch panel 513 may display a Graphical User Interface (GUI) which may control, for example, various functions of the third electronic device 500. The GUI may be a GUI for controlling, for example, a sound or image output.

According to an embodiment, the touch panel 513 may receive a user input, for example, a touch input or a hovering input from the user. According to an embodiment, the third electronic device 500 and the main frame 512 may be connected to each other through an interface such as a USB. For example, a USB of the communication interface 506 and a USB (not shown) installed in the outside of the main frame 512 are connected to each other, and thus the third electronic device 500 and the fourth electronic device 510 may be connected to each other. Further, for example, the user input received by the touch panel 513 may be transferred to the processor 502 of the third electronic device 500 through the USB. According to an embodiment, the processor 502 of the third electronic device 500 may control the third electronic device 500 to perform a function corresponding to the user input made through the touch panel 513. For example, the third electronic device 500 may adjust a volume or control reproduction of a still image or a dynamic image according to a touch input received by the touch panel 513.

According to an embodiment, the connector 514 may be combined with an electrical access unit of the third electronic device 500 and thus the fourth electronic device 510 may communicate with the third electronic device 500. According to an embodiment, the fourth electronic device 510 may receive power from the third electronic device 500 through the connector 514.

According to an embodiment, the location adjustor 515 may adjust a location of the third electronic device 500. For example, as illustrated in FIG. 5, the location adjustor 515 may be implemented in a wheel form. For example, the user may move the location of the third electronic device 500 attached to the main frame 512 in a left or right direction by rolling the wheel type location adjustor 515 in a left or right direction. According to another embodiment, the location adjustor 515 may be implemented in a wheel form to move the location of the third electronic device 500 in an up or down direction.

According to an embodiment, the cover 516 may cover the third electronic device 500 attached to the fourth electronic device 510, so as to fix the third electronic device 500 to the main frame 512 of the fourth electronic device 510.

According to various embodiments, the fourth electronic device 510 may not include at least one of the mounting part 511, the main frame 512, the touch panel 513, the connector 514, the location adjustor 515, and the cover 516. For example, the fourth electronic device 510 may include the mounting part 511, the main frame 512, and the connector 514.

According to various embodiments, the system for providing the virtual reality service may include devices for configuring, for example, IllumiRoom.

According to various embodiments, an electronic device may include: a memory that stores content of a 2D format; and a processor, wherein the processor may be configured to identify an attribute of the content of the 2D format to be provided by the electronic device or situation information, to provide a first content of a first virtual reality format corresponding to the content when the attribute or the situation information is a first attribute or first situation information, and configure to provide a second content of a second virtual reality format corresponding to the content when the attribute or the situation information is a second attribute or second situation information.

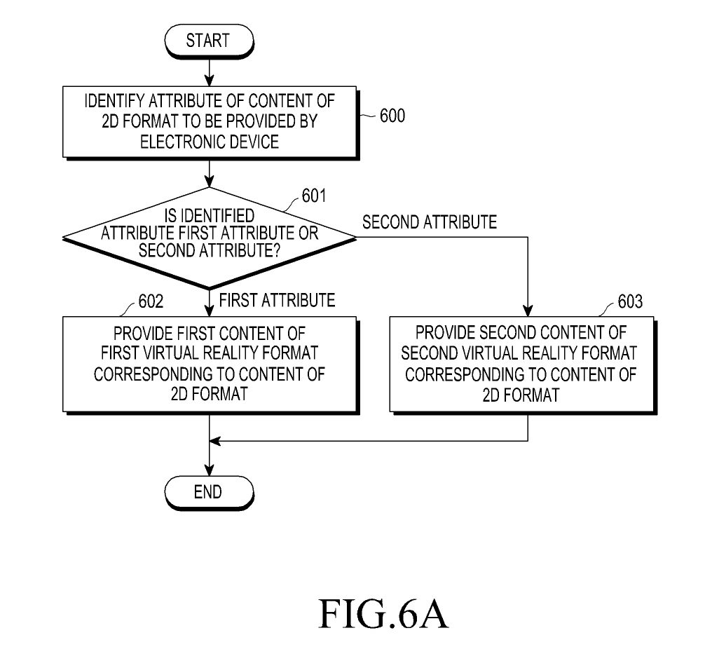

FIGS. 6A and 6B are flowcharts illustrating example operations for providing a virtual reality content according to various example embodiments. According to various embodiments, operations 600 to 603 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

According to FIG. 6A, in operation 600, the electronic device 101 may identify an attribute of content of a 2D format to be provided by the electronic device 101. For example, the electronic device 101 may identify an attribute of a provided 2D map.

The electronic device 101 may identify the identified attribute is a first attribute or a second attribute in operation 601. The electronic device 101 may perform operation 602 when the identified attribute is the first attribute, and perform operation 603 when the identified attribute is the second attribute. For example, the electronic device 101 may identify, as the attribute, a genre of content of a 2D format (for example, 2D map), an extension, display information included in the content of the 2D format (for example, 2D map), a link related to the content of the 2D format (for example, 2D map), display information of an application or a file, and metadata.

For example, when the genre of the content of the 2D format is a first genre (for example, action movie), the electronic device 101 may determine that the attribute of the content of the 2D format is the first attribute. Further, when the genre of the content of the 2D format is a second genre (for example, comic video), the electronic device 101 may determine that the attribute of the content of the 2D format is the second attribute.

For example, when the extension of the content of the 2D format is a first extension (for example, WMV, MP4, AVI), the electronic device 101 may determine that the attribute of the content of the 2D format is the first attribute. Further, when the extension of the content of the 2D format is a second extension (for example, PG; bmp, or png), the electronic device 101 may determine that the attribute of the content of the 2D format is the second attribute.

For example, when the display information included in the content of the 2D format is first display information (for example, traffic information), the electronic device 101 may determine that the attribute of the content of the 2D format is the first attribute. Further, when the display information included in the content of the 2D format is second display information (for example, location search information), the electronic device 101 may determine that the attribute of the content of the 2D format is the second attribute.

For example, when the link related to the content of the 2D format is a first link (for example, webpage address), the electronic device 101 may determine that the attribute of the content of the 2D format is the first attribute. Further, when the link related to the content of the 2D format is a second link (for example, video reproduction address), the electronic device 101 may determine that the attribute of the content of the 2D format is the second attribute.

For example, when the display information of the application or file related to the content of the 2D format is first display information (for example, aerial view), the electronic device 101 may determine that the attribute of the content of the 2D format is the first attribute. Further, when the display information of the application or file related to the content of the 2D format is second display information (for example, street view), the electronic device 101 may determine that the attribute of the content of the 2D format is the second attribute.

For example, when the metadata of the content of the 2D format is first metadata (for example, a production company, a director, and a running time of a movie), the electronic device 101 may determine that the attribute of the content of the 2D format is the first attribute. Further, when the metadata of the content of the 2D format is second metadata (for example, a title, a plot, and a rating of a movie), the electronic device 101 may determine that the attribute of the content of the 2D format is the second attribute.

In operation 602, the electronic device 101 may provide a first content of a first virtual reality format corresponding to the content of the 2D format. For example, when there is a 3D map associated with the 2D map (for example, when the third map associated with the 2D map is stored in the memory included in the electronic device 101 or the electronic device (for example, the electronic device 104 or the server 106) connected to the electronic device 101 or when information on the 3D map (for example, link) is included in metadata on a file of the 2D map), the electronic device 101 may display a screen of the 3D map as the content of the virtual reality format for the 2D map.

In operation 603, the electronic device 101 may provide a second content of a second virtual reality format corresponding to the content of the 2D format. For example, when a street view type map for a particular region exists in connection with the 2D map (for example, when the street view type map related to the 2D map is stored in the memory included in the electronic device 101 or the electronic device (for example, the electronic device 104 or the server 106) connected to the electronic device 101 or when information on the street view type map (for example, link) is included in metadata on a file of the 2D map), the electronic device 101 (for example, processor 120) may display the street view type map.

According to various embodiments, in order to provide the first content or the second content, the electronic device 101 may identify an object included in the content of the 2D format and determine a virtual reality content corresponding to the identified object as at least a part of a corresponding content between the first content and the second content.

According to an embodiment, in order to provide the first content or the second content, the electronic device 101 may change the 2D format of the content into a corresponding virtual reality format between the first virtual reality format and the second virtual reality format.

According to an embodiment, in order to provide the first content or the second content, when the electronic device 101 provides another content, the electronic device 101 may provide a third content of a third virtual reality format corresponding to the other content being provided at least temporarily simultaneously with a corresponding content between the first content and the second content.

According to an embodiment, in order to provide the first content or the second content, the electronic device 101 (for example, processor 120) may provide a corresponding content between the first content and the second content through the display included in the external electronic device functionally connected to the electronic device 101.

According to FIG. 6B, in operation 610, the electronic device 101 may identify an attribute or situation information of the content of the 2D format to be provided by the electronic device 101. For example, the electronic device 101 may identify an attribute or situation information of the 2D map. According to various embodiments, operations 610 to 612 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

In operation 611, when the identified attribute or situation information is a first attribute or first situation information, the electronic device 101 may provide a first content of a first virtual reality format corresponding to the content of the 2D format. For example, the electronic device 101 (for example, processor 120) may identify, as the attribute, a genre of the content of the 2D format (for example, 2D map), an extension, display information included in the content of the 2D format (for example, 2D map), a link related to the content of the 2D format (for example, 2D map), display information of an application or a file, and metadata, or identify, as the situation information, execution information (for example, whether to execute multitasking, a multi-window, or a popup window) of the electronic device 101 that provides the content of the 2D format (for example, 2D map), user's input information, and a current location.

For example, when the execution information of the electronic device 101 is first execution information (for example, multi-window), the electronic device 101 may determine that the situation information of the content of the 2D format is first situation information. Further, when the execution information of the electronic device 101 is second execution information (for example, popup window), the electronic device 101 may determine that the situation information of the content of the 2D format is second situation information.

For example, when the user's input information is first input information (for example, Point Of Interest (POI) display input), the electronic device 101 may determine that the situation information of the content of the 2D format is first situation information. Further, when the user's input information is second input information (for example, an input for a map search), the electronic device 101 may determine that the situation information of the content of the 2D format is second situation information.

For example, when the current location information of the electronic device 101 is first location information (for example, home), the electronic device 101 may determine the situation information of the content of the 2D format is first situation information. Further, when the current location information of the electronic device 101 is second location information (for example, office), the electronic device 101 may determine that the situation information of the content of the 2D format is second situation information.

For example, when the identified situation information corresponds to reproduction of a 2D movie as well as the 2D map, the electronic device 101 (for example, the processor 120) may generate and display a virtual reality content including an area for displaying the 2D map and an area for displaying the 2D movie.

In operation 612, when the identified attribute or situation information is a second attribute or second situation information, the electronic device 101 (or the processor 120) may provide a second content of a second virtual reality format corresponding to the content of the 2D format. For example, when the identified situation information corresponds to displaying only the 2D map, the electronic device 101 (for example, the processor 120) may display the 2D map in an extended window size or a screen size according to an extended screen display method.

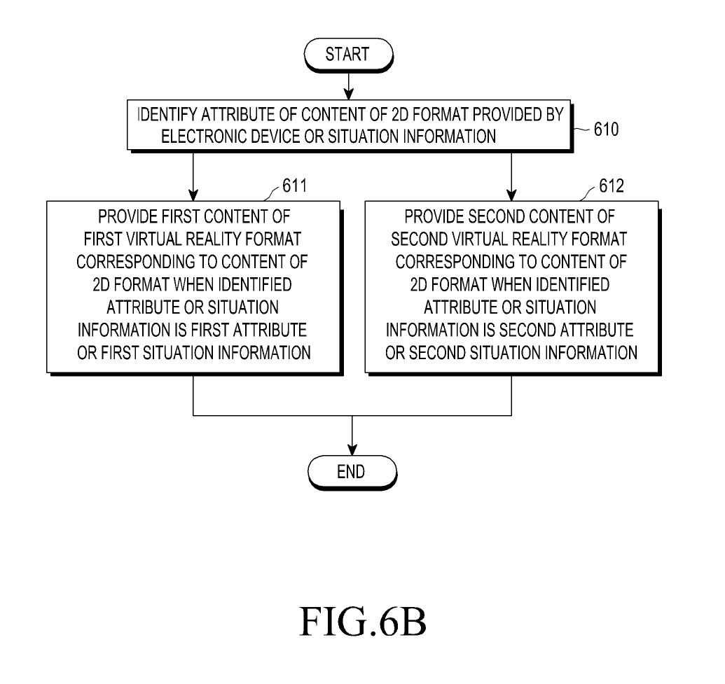

FIG. 7 is a flowchart illustrating an example operation for providing a virtual reality content according to various example embodiments. According to various example embodiments, operations 700 to 750 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

According to FIG. 7, in operation 700, the electronic device 101 may detect activation of a virtual reality mode. According to an embodiment, the electronic device 101 may detect an event for changing the mode into the virtual reality mode while the first content is provided. The event may include, for example, an event for receiving an input for the change into the virtual reality mode through the input/output interface 150 of the electronic device 101, an event for establishing a connection with an external device (for example, a head mounted device) through which the electronic device 101 provides a virtual reality service, an event for combining the electronic device 101 with the head mounted device, an event by which the user wears the head mounted device, or a combination thereof.

In operation 710, the electronic device 101 may acquire content information of the first content provided (or to be provided).

According to an embodiment, when the event for the change into the virtual reality mode is detected, the electronic device 101 (for example, the processor 120) may acquire content information including a name, type, attribute, or situation information of the provided content.

In operation 720, the electronic device 101 may identify an attribute and situation information related to the display of the content based on the acquired content information.

The attribute related to the display may include, for example, a link of the content, display information of a connected application or file, or metadata. The situation information related to the display may include, for example, execution information (for example, whether to execute multitasking, a multi-window, or a popup window) of the electronic device 101 that provides the content, user's input information (for example, POI display input), or a current location.

In operation 730, the electronic device 101 may identify one or more content display methods based on the identified attribute. The content display method may include, for example, a first display method of reproducing and displaying a virtual reality content, a second display method of combining the virtual reality content with an additional content and reproducing and displaying the combined content, a third display method of combining a 2D virtual space and a 3D virtual space and generating and displaying a virtual reality content that shows at least one 2D content within the 3D virtual space, a fourth display method of executing an application that provides a virtual reality service and displaying an execution screen of a virtual reality format, and a fifth display method of extending and displaying a window size or a screen size in which the content is displayed.

For example, when the identified attribute is the first attribute (for example, when the content is linked to a 3D content), the electronic device 101 may select, as the content display method, the first display method and the third display method from the plurality of content display methods (for example, first to fifth display methods). Further, for example, when the identified attribute is the second attribute (for example, content which can be rendered in three dimensions), the electronic device 101 may select, as the content display method, the first display method, the fourth display method, and the fifth display method from the plurality of content display methods (for example, first to fifth display methods).

In operation 740, the electronic device 101 may determine at least one content display method among the plurality of identified content display methods based on the identified situation information.

According to an embodiment, the electronic device 101 may identify (for example, select) at least one content display method according to user selection. For example, the electronic device 101 may provide a user interface for selecting at least one of the plurality of content display methods, and display content of a virtual reality format for the content by using the at least one content display method selected through the user interface.

For example, when the first and third display methods are selected as the content display method based on the fact that the identified attribute of the content is the first attribute, the electronic device 101 may display each of first and second user interfaces corresponding to the first and third display methods, respectively, through the display (or projector). When the user selects the first user interface, the electronic device 101 may display the content of the virtual reality format by using the first display method. Further, when the user selects the second user interface, the electronic device 101 may display the content of the virtual reality format by using the second display method.

According to an embodiment, the electronic device 101 may determine at least one content display method based on a setting value of a content server that provides the content. For example, when the setting value of the content server that provides the content is a first setting value (for example, first display method), the electronic device 101 may select, as the content display method, the first display method from the plurality of content display methods (for example, first to fifth display methods).

According to an embodiment, the electronic device 101 (for example, processor 120) may automatically determine the content display method by using a genre, an extension, and screen display information of the content. For example, when the content is media data corresponding to a movie, the electronic device 101 (for example, processor 120) may determine, as the content display method, the third display method to reproduce the media data by using a virtual reality application in order to display the media data in the virtual reality format.

In operation 750, the electronic device 101 (for example, processor 120) may display the virtual reality content for the content based on the at least one determined content display method.

According to an embodiment, when the content is a 360 degree panorama image and the determined content display method is the first display method, the electronic device 101 (for example, processor 120) may display the 360 degree panorama image. The 360 degree panorama image may be an image photographed in a panorama type while a photographing device rotates 360 degrees. The electronic device 101 (for example, processor 120) may display the 360 degree panorama image.

For example, the electronic device 101 (for example, processor 120) may render and display a view area corresponding to a view which the user watches in the 360 degree panorama image. The electronic device 101 (for example, processor 120) may change the view area according to a result of the performance of head tracking, and render and display the changed view area.

Contents which can be displayed in the virtual reality format based on the first display method may include, for example, a 360 degree panorama image, a 360 degree panorama video, a 3D game, a first-person narrative movie content, a stereoscopic image, a street view type map content showing a street in three dimensions, an aerial view type map content viewed from the sky, and a store view type map content showing the inside of a store.

According to an embodiment, when the content is a 2D map including an additional content (for example, traffic information) and the determined content display method is the second display method, the electronic device 101 (for example, processor 120) may display a 3D map including some areas, in which traffic information is displayed, corresponding to the 2D map. For example, the electronic device 101 (for example, processor 120) may display the 3D map on which a popup screen showing traffic information is displayed.

According to an embodiment, when the content is a 2D map and the determined content display method is the third display method, the electronic device 101 (for example, processor 120) may generate and display a virtual reality content showing the 2D map in some areas within a virtual space. For example, the electronic device 101 (for example, processor 120) may generate a virtual reality content showing some areas for displaying a plurality of contents such as configuration screens of various provided applications, an execution screen of the executed application, a reproduction screen played through a media player, and a standby screen of the electronic device 101 within the virtual space, and reproduce and display the generated virtual reality content.

According to an embodiment, when the content is a 2D movie and the determined content display method is the fourth display method, the electronic device 101 (for example, processor 120) may execute an application that provides a virtual reality service for the 2D movie and display an execution of the application of the virtual reality format.

For example, the electronic device 101 may execute an application that implements a virtual reality space in a movie theater form and display an application execution screen of the virtual reality format that gives the feeling as if the 2D movie is watched in the movie theater. The application execution screen may include a 360 degree panorama movie theater image including some areas for displaying the 2D movie. Accordingly, it is possible to provide the immersion to the user as if the user watches a movie in a movie theater.

According to an embodiment, when the first content is the 2D map and the determined content display method is the fifth display method, the electronic device 101 may display the 2D map in the extended window size or the screen size.

According to various embodiments, when a plurality of contents are provided, the electronic device 101 may select some of the plurality of contents and display virtual reality contents corresponding to the selected contents. When the plurality of contents are simultaneously provided, the electronic device 101 (for example, processor 120) may generate and display virtual reality contents based on different content display methods.

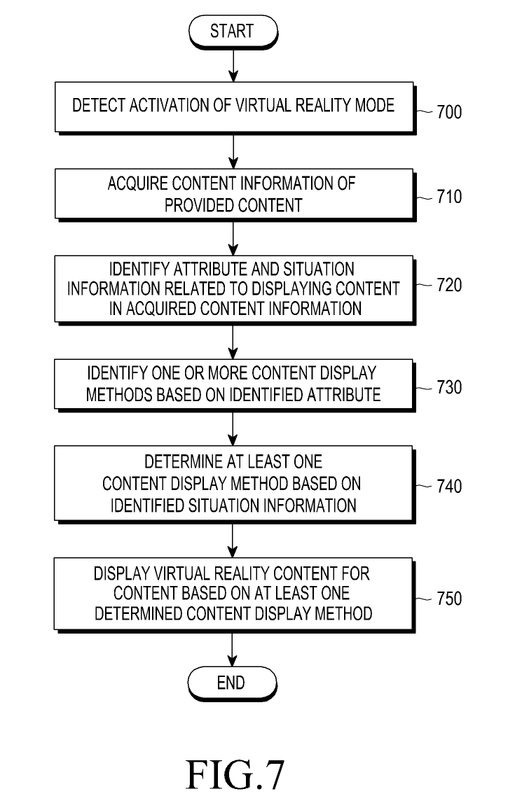

FIG. 8 is a flowchart illustrating an example operation for displaying content of a virtual reality format for a single content according to various example embodiments. According to various example embodiments, operations 800 to 830 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

Referring to FIG. 8, when a normal display mode, in which one content is provided (or will be provided), is changed into a virtual reality mode in operation 800, the electronic device 101 may determine whether the provided content is a virtual reality content in operation 810. The electronic device 101 may perform operation 820 when the provided content is the virtual reality content, and perform operation 830 when the provided content is not the virtual reality content. According to an embodiment, when the electronic device 101 is connected to an external electronic device (for example, through wired or wireless communication or physically) while the content is provided in the normal display mode, the electronic device 101 may activate the virtual reality mode.

According to an embodiment, when content of a 3D format corresponding to a provided content of a 2D format (for example, 2D map) exists, the electronic device 101 may determine that the provided content of the 2D format is the virtual reality format. For example, a 3D map (for example, a linked 3D map) corresponding to the provided 2D map exists, the electronic device 101 may determine that the 2D map is the virtual reality content. For example, when the provided 2D map can be rendered in three dimensions, the electronic device 101 may determine that the 2D map is the virtual reality content.

In operation 820, the electronic device 101 may provide the virtual reality content based on the first display method. According to an embodiment, when the provided content is the virtual reality content, the electronic device 101 (for example, processor 120) may reproduce and display the virtual reality content.

In operation 830, the electronic device 101 may provide the content based on the third display method. According to an embodiment, when the provided content is not the virtual reality content, the electronic device 101 may generate a virtual reality content that shows some areas to provide the content within a virtual space, and reproduce and display the generated virtual reality content. For example, when an input for a change into the virtual reality mode is received while a 2D map displayed, the electronic device 101 may determine whether the displayed 2D map is the virtual reality content based on content information of the 2D map. When there is no 3D map associated with the displayed 2D map or when 3D rendering cannot be performed, the electronic device 101 may generate a virtual reality content that shows some areas displaying the 2D map within a virtual space, and reproduce and display the generated virtual reality content.

When the content provided (or to be provided) is the virtual reality content, the virtual reality content may be provided based on the first display method in operation 820, but various embodiments of the present disclosure are not limited thereto. For example, according to various embodiments, when the provided content is the virtual reality content, the virtual reality content may be provided based on the second display method.

When the content provided (or to be provided) is not the virtual reality content, the virtual reality content may be provided based on the third display method in operation 830, but various embodiments of the present disclosure are not limited thereto. For example, according to various embodiments, when the provided content is not the virtual reality content, the virtual reality content may be provided based on the first display method.

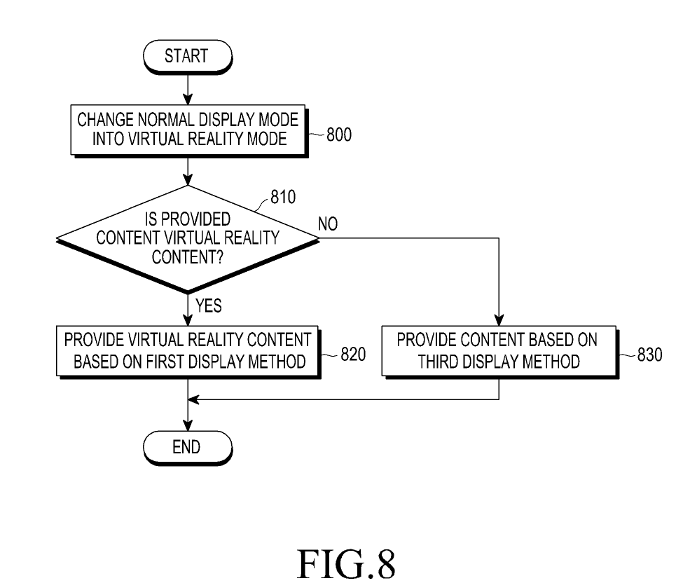

FIG. 9 is a flowchart illustrating an example operation for displaying content of a virtual reality format for one or more contents according to various example embodiments. According to various example embodiments, operations 900 to 950 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

According to FIG. 9, when a normal display mode in which one content is provided is changed into a virtual reality mode in operation 900, the electronic device 101 may determine whether the provided content is a virtual reality content in operation 910. The electronic device may perform operation 920 when the provided content is the virtual reality content, and perform operation 950 when the provided content is not the virtual reality content.

The electronic device 101 may determine whether the provided content is a single content in operation 920. The electronic device 101 may perform operation 930 when the content provided (to be provided) is the signal content for displaying one data on the screen, and perform operation 940 when the provided content is not the single content. According to an embodiment, the electronic device 101 may determine whether the provided content is the single content based on content information of the provided content. For example, the electronic device 101 may identify metadata of the content information and, when the provided content may display one data on the screen, determine that the provided content is the single content.

In operation 930, the electronic device 101 may provide the virtual reality content based on the first display method. For example, when the provided content is a 2D movie which can be rendered in three dimensions, the electronic device 101 may render 2D movie in three dimensions and display the movie.

In operation 940, the electronic device 101 may provide the virtual reality content based on the second display method. According to an embodiment, when the provided content is the virtual reality content and an additional content is included in the virtual reality content, the electronic device 101 (for example, processor 120) may display the virtual reality content with the additional content.

For example, when the provided content is a 2D map which can be rendered in three dimensions and the 2D map includes traffic information, the electronic device 101 may render the 2D map in three dimensions and display the 3D map such that traffic information is shown in some areas of the rendered 3D map.

According to various embodiments, when the provided content is a 3D movie and the additional content includes video information, subtitle information, and advertisement information, the electronic device 101 (for example, processor 120) may reproduce and display the 3D movie including some areas in which the video information, the subtitle information, and the advertisement information are shown. Some areas may include a transparent screen or an opaque screen.

In operation 950, the electronic device 101 may provide the virtual reality content based on the third display method. According to an embodiment, when the content is a 2D movie, the electronic device 101 (for example, 120) may generate a virtual reality content that shows the 2D movie in some areas within a virtual space, and reproduce and display the generated virtual reality content.

For example, when there is an additional content (for example, movie information) related to the 2D movie, the electronic device 101 shows movie information in a partial area within the virtual space, generates a virtual reality content that shows the 2D movie in another partial area, and reproduces and displays the generated virtual reality content.

When the provided content is a signal content, the electronic device 101 may provide the virtual reality content based on the first display method in operation 930, but various embodiments of the present disclosure are not limited thereto. For example, according to various embodiments, when the provided content is the single content, the electronic device 101 may provide the virtual reality content based on the second display method or the third display method.

When the provided content is not the signal content, the electronic device 101 may provide the virtual reality content based on the second display method in operation 940, but various embodiments of the present disclosure are not limited thereto. For example, according to various embodiments, when the provided content is not the single content, the electronic device 101 may provide the virtual reality content based on the first display method or the third display method.

When the provided content is not the virtual reality content, the electronic device 101 may provide the virtual reality content based on the third display method in operation 950, but various embodiments of the present disclosure are not limited thereto. For example, according to various embodiments, when the provided content is not the virtual reality content, the electronic device 101 may provide the virtual reality content based on the first display method or the second display method.

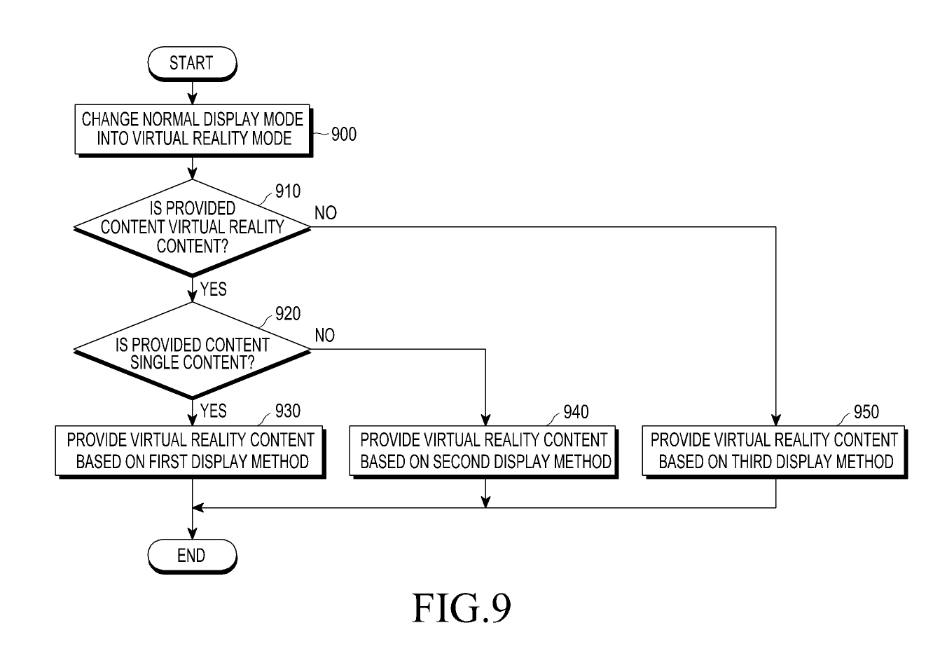

FIG. 10 is a flowchart illustrating an example operation for displaying content of a virtual reality format by using a virtual reality content corresponding to a provided content or a virtual reality application according to various example embodiments. According to various example embodiments, operations 1000 to 1070 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

When a normal display mode in which content is provided is changed into a virtual reality mode in operation 1000, the electronic device 101 may determine whether the provided content is a virtual reality content in operation 1010. The electronic device 101 may perform operation 1020 when the provided content is the virtual reality content, and perform operation 1030 when the provided content is not the virtual reality content.

In operation 1020, the electronic device 101 may provide the virtual reality content based on the first display method.

The electronic device 101 may determine whether there is a virtual reality content corresponding to the provided content in operation 1030. The electronic device 101 may perform operation 1040 when there is the virtual reality content corresponding to the provided content, and perform operation 1050 when there is no virtual reality content corresponding to the provided content.

According to an embodiment, the electronic device 101 may determine whether the virtual reality content corresponding to the provided content is stored in the memory 130 included in the electronic device 101. For example, when the virtual reality content is stored in the memory 130, the electronic device 101 may determine that the virtual reality content corresponding to the provided content exists.

According to an embodiment, the electronic device 101 may determine whether the virtual reality content corresponding to the provided content is stored in the server 106 connected to the electronic device 101. For example, the electronic device 101 may make a request for the virtual reality content corresponding to the provided content to the server 106 and, when the virtual reality content corresponding to the provided content is received from the server 106, determine that the virtual reality content corresponding to the provided content exists.

The electronic device 101 may change the provided content into the virtual reality content associated with the content in operation 1040, and provide the changed virtual reality content based on the first display method in operation 1020. According to an embodiment, when there is a virtual reality content such as an image photographed in the first-person viewpoint or a stereo image corresponding to the reproduced 2D movie, the electronic device 101 may change the 2D movie into the image photographed in the first-person viewpoint or the stereo image. The electronic device 101 may reproduce and display the changed image photographed in the first-person viewpoint or stereo image. For example, the electronic device 101 may divide the reproduction screen of the image photographed in the first-person viewpoint or the stereo image into a left eye screen and a right eye screen and display the left eye screen and the right eye screen.

According to various embodiments, when there is a virtual reality content such as a street view type map, an aerial view type map, or a store view type map corresponding to the provided 2D map, the electronic device 101 may change the provided 2D map into one of the street view type map, the aerial view type map, and store view type map. The electronic device 101 may display one of the changed street view type map, aerial view type map, and store view type map.

According to various embodiments, the virtual reality content corresponding to the provided content may be stored in the electronic device 101 or stored in an external device (for example, a virtual reality device, a head mounted device, or a server) which can provide the virtual reality service. The virtual reality content may be received from the server after a request for a relevant content corresponding to the content provided by the electronic device 101 is transmitted to the server.

The electronic device 101 may determine whether there is a virtual reality application for implementing the provided content as the virtual reality in operation 1050. The electronic device 101 may perform operation 1060 when the virtual reality application exists, and perform operation 1070 when the virtual reality application does not exist.

In operation 1060, the electronic device 101 may provide the content based on the fourth display method. According to an embodiment, when there is no 3D video corresponding to a provided 2D video and there is a virtual reality application for providing a virtual reality service corresponding to the 2D video, the electronic device 101 may execute the virtual reality application and display an execution screen of a virtual reality format. For example, when there is the virtual reality application for providing the virtual reality service corresponding to a 2D movie, the electronic device 101 may execute the virtual reality application, and reproduce and display the 2D movie through the executed virtual reality application. The electronic device 101 may display the execution screen of the virtual reality format as if the user watches the 2D movie in a movie theater. In this case, the electronic device 101 may provide seamless 2D video according to a reproduction environment change by executing the virtual reality application of the 2D video.

According to various embodiments, when there is a virtual reality application for a provided 2D game, the electronic device 101 may store execution information of a 2D game content (for example, game data played up to now) and execute the virtual reality application, so as to provide a game content of a virtual reality format in which the stored execution information is reflected.

In operation 1070, the electronic device 101 may provide the content based on the third display method. According to an embodiment, when there is no 3D video corresponding to the 2D video and there is no virtual reality application for providing the virtual reality service for the 2D video, the electronic device 101 (for example, processor 120) may generate a virtual reality content that shows the 2D video in a partial area within a virtual space, and reproduce and display the generated virtual reality content.

When the provided content is the virtual reality content or when the provided content is not the virtual reality content and there is the virtual reality content corresponding to the provided content, the electronic device 101 may change the provided content into the corresponding virtual reality content and provide the virtual reality content based on the first display method in operation 1020, but various embodiments of the present disclosure are not limited thereto. For example, according to various embodiments, when the provided content is the virtual reality content or when the provided content is not the virtual reality content and there is the virtual reality content corresponding to the provided content, the electronic device 101 may change the provided content into the corresponding virtual reality content and provide the virtual reality content based on the third display method or the fourth display method.

When there is the virtual reality application corresponding to the provided content, the electronic device 101 may provide the virtual reality content based on the fourth display method in operation 1060, but various embodiments of the present disclosure are not limited thereto. For example, according to various embodiments, when there is a virtual reality application for the provided content, the electronic device 101 may provide the virtual reality content based on the first display method or the third display method.

When there is no virtual reality application for the provided content, the electronic device 101 may provide the virtual reality content based on the third display method in operation 1070, but various embodiments of the present disclosure are not limited thereto. For example, according to various embodiments, when there is no virtual reality application for the provided content, the electronic device 101 may provide the virtual reality content based on the first display method or the fourth display method.

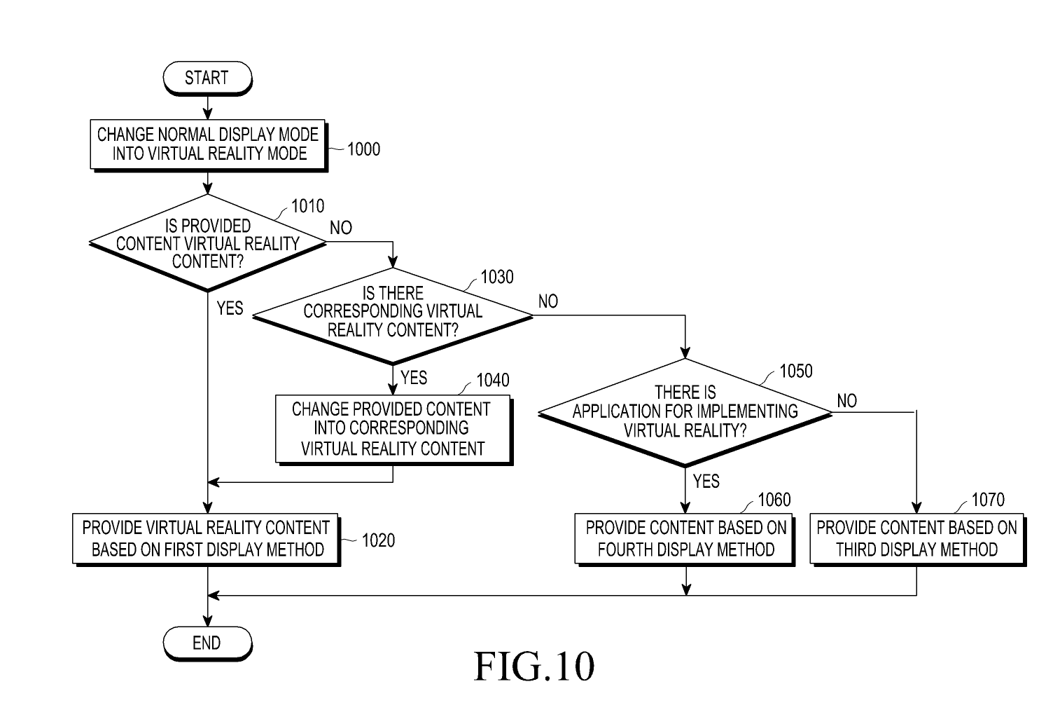

FIG. 11 is a flowchart illustrating an example operation for displaying content of a virtual reality format when a multitasking function is performed according to various example embodiments. According to various example embodiments, operations 1100 to 1140 may be performed through the electronic device (the electronic device 101, 104, or 201, the server 106, the first electronic device 400, or the third electronic device 500), the processor 120 or 210, the program module 310, the VR application 385, the graphic manager 351, or the VR manager 353.

When a normal display mode in which content is provided is changed into a virtual reality mode in operation 1100, the electronic device 101 may determine whether the provided content is a virtual reality content in operation 1110. The electronic device 101 may perform operation 1120 when the provided content is the virtual reality content, and perform operation 1140 when the provided content is not the virtual reality content.

The electronic device 101 may determine whether the multitasking function is performed in operation 1120. The electronic device 101 may perform operation 1130 when the multitasking function is not performed, and perform operation 1140 when the multitasking function is performed. The multitasking function refers to, for example, a function for overlappingly displaying (or simultaneously executing) execution screens for a plurality of executed applications. The plurality of applications may include a foreground application displayed on the display 160 and a background application, which is not displayed on the display and is overlaid on the foreground application.

In operation 1130, the electronic device 101 may provide the content based on the first display method. According to an embodiment, the electronic device 101 (for example, processor 120) may provide an execution screen of a virtual reality format for one executed virtual reality application.

When the provided content performs the multitasking function but it not the virtual reality content, the electronic device 101 may provide the content based on the third display method in operation 1140.

According to an embodiment, the electronic device 101 that performs the multitasking function may display, through the display 160, or not display execution screens of some of at least one executed background application other than at least one foreground application currently executed. For example, the electronic device 101 may display the execution screens for some of the background applications in a form of icons on a notification bar.

For example, the electronic device 101 may generate a virtual reality content that shows execution screens of at least one foreground application in a partial area within the virtual space and shows execution screens for at least one background application in another partial area, and reproduce and display the generated content.

According to various embodiments, the electronic device 101 may show a floating icon of the background application which is not displayed in a partial area within the virtual space, generate a virtual reality content that shows a notification information in another partial area, and reproduce and display the generated virtual reality content. Further, the electronic device 101 may place an execution screen of the background application, which is not displayed, and a part of the notification screen in an area which does not correspond to a user's view within the virtual space.

When the provided content is the virtual reality content and the electronic device 101 does not perform the multitasking function, the electronic device 101 may provide the content based on the first display method in operation 1130, but various embodiments of the present disclosure are not limited thereto. For example, according to various embodiments, when the provided content is the virtual reality content and the electronic device 101 does not perform the multitasking function, the electronic device 101 may provide the content based on the third display method.

When the provided content is not the virtual reality content and the electronic device 101 performs the multitasking function, the electronic device 101 may provide the content based on the third display method in operation 1140, but various embodiments of the present disclosure are not limited thereto. For example, according to various embodiments, when the provided content is not the virtual reality content and the electronic device 101 performs the multitasking function, the electronic device 101 may provide the content based on the first display method.

According to various embodiments of the present disclosure to achieve the above description, a method by an electronic device including a processor may include: an operation of identifying an attribute of content of a 2D format to be provided by the electronic device; an operation of providing a first content of a first virtual reality format corresponding to the content by using the processor when the attribute is a first attribute; and an operation of providing a second content of a second virtual reality format corresponding to the content by using the processor when the attribute is a second attribute.

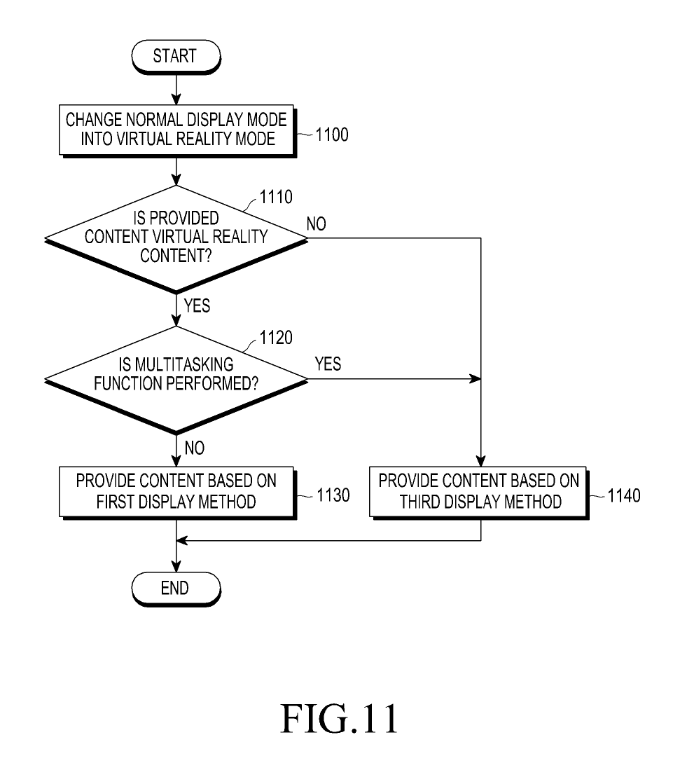

FIGS. 12A and 12B are diagrams illustrating examples of an example operation of activating a virtual reality mode according to various example embodiments.

Referring to FIG. 12A, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may display an icon 1201 for providing a virtual reality content for a map application on an execution screen 1200 of the executed map application. According to an embodiment, when the displayed icon 1201 is selected, the electronic device 101 (for example, the processor 120) may recognize an event for changing a normal display mode for providing a map content into a virtual reality mode for providing a virtual reality content for the map content.

Referring to FIG. 12B, for example, when the user wears a head mounted device 1211 on the user's head 1210 or the electronic device 101 is mounted to the head mounted device 1211, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may recognize an event for activating the virtual reality mode.

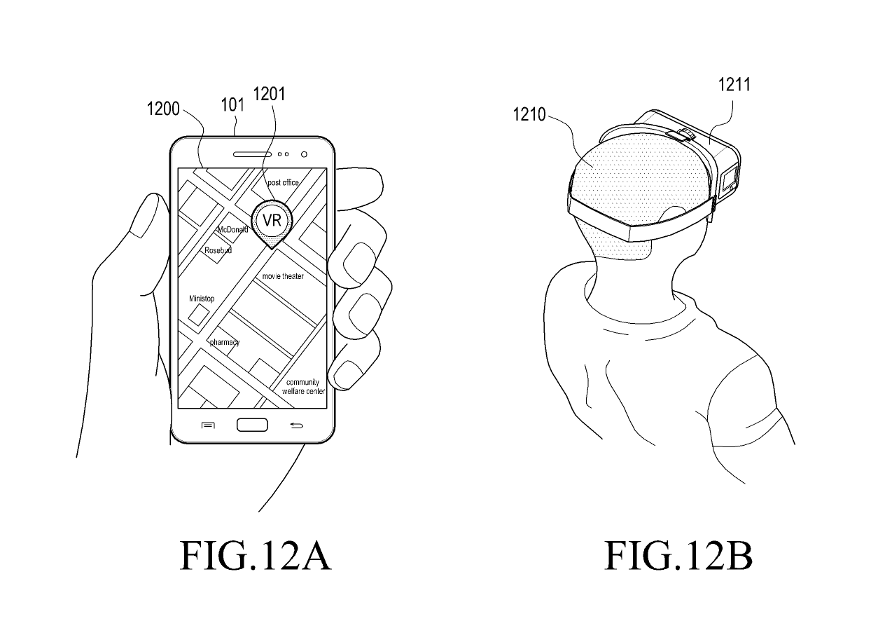

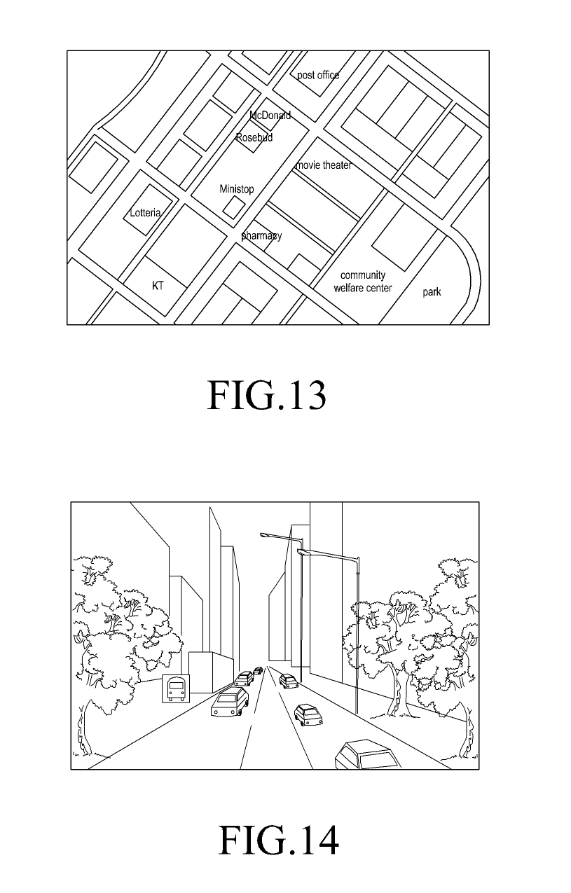

FIGS. 13 and 14 are diagrams illustrating examples for describing an attribute related to displaying content according to various example embodiments.

Referring to FIGS. 13 and 14, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may check an attribute related to displaying a 2D map and identify whether there is a 2D map in an extended window size or a screen size as illustrated in FIG. 13 or a street view type map as illustrated in FIG. 14 which can be displayed at a current location according to the 2D map. For example, the electronic device 101 may identify whether information on a street view type map file (for example, link or map file) is included in stored information (for example, metadata) connected to the 2D map. Further, the electronic device 101 may identify (for example, search for) whether there is a street view type map file in the memory 130 included in the electronic device 101 or an external server connected to the electronic device 101.

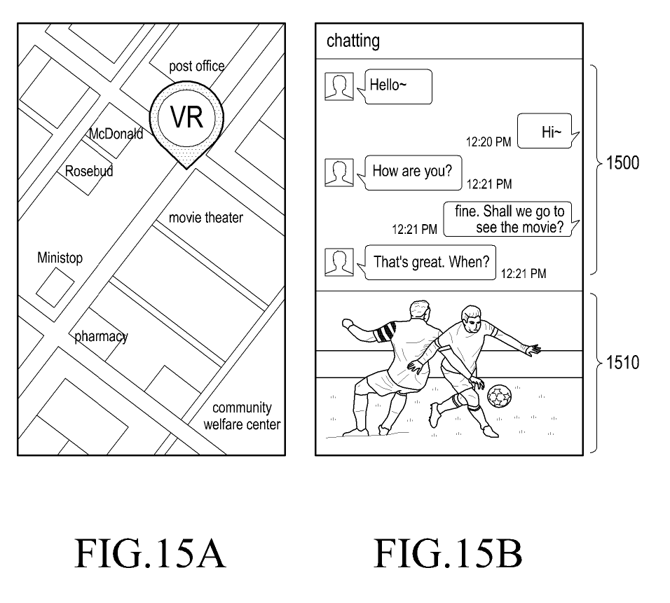

FIGS. 15A and 15B are diagrams illustrating examples describing situation information related to displaying content according to various example embodiments.

Referring to FIGS. 15A and 15B, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may check situation information related to displaying content and identify whether one map application is executed as illustrated in FIG. 15A or a plurality of applications (for example, a chatting application 1500 and a video reproducing application 1510) are executed and displayed on one screen as illustrated in FIG. 15B.

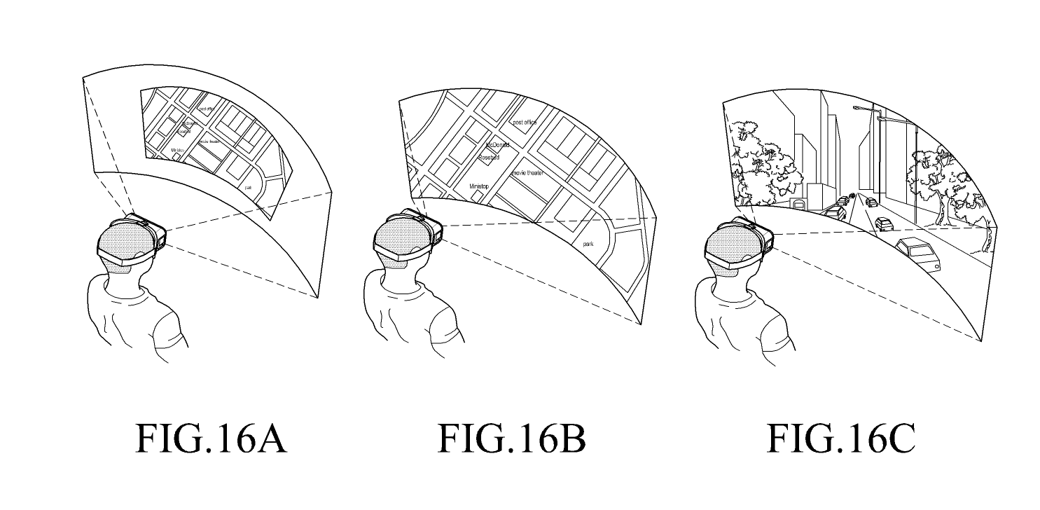

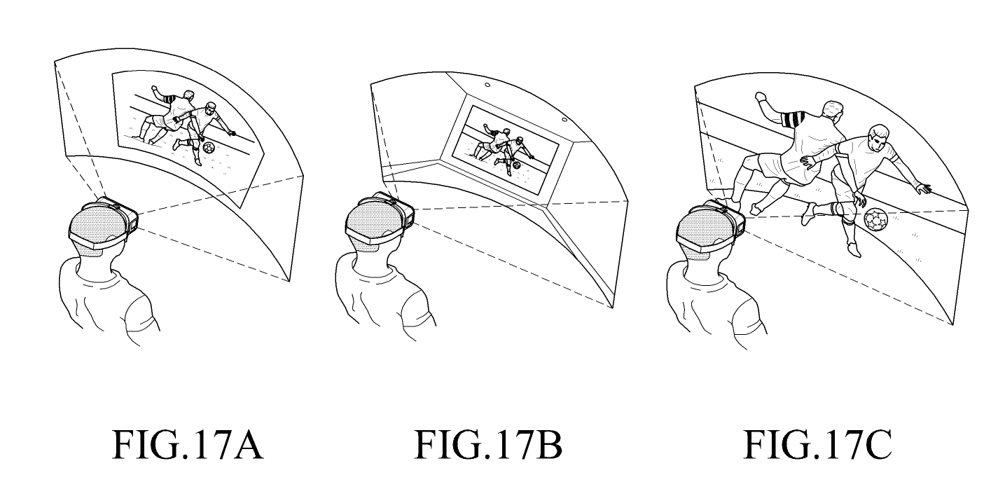

FIGS. 16A, 16B, 16C and FIGS. 17A, 17B and 17C are diagrams illustrating examples describing a content display method according to various example embodiments.

Referring to FIGS. 16A to 16C, when a map content is provided, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may acquire map content information of the map content, identify an attribute and/or situation information in the acquired map content information, and determine a content display method based on the identified attribute and/or situation information. The content display method may include a method of generating and displaying a virtual reality content that shows a 2D map in a partial area within a virtual space as illustrated in FIG. 16A, a method of displaying a 2D map in an extended window size or a screen size as illustrated in FIG. 16B, and a method of displaying a 3D map corresponding to the 2D map as illustrated in FIG. 16C.

Referring to FIGS. 17A to 17C, the content display method may include a method of generating and displaying a virtual reality content that shows a 2D movie in a partial area within a virtual space as illustrated in FIG. 17A, a method of executing a virtual reality application related to the 2D movie and displaying a virtual reality content for the 2D movie through the executed virtual reality application as illustrated in FIG. 17B, and a method of rendering, in three dimensions, the 2D movie which can be rendered in three dimensions, and displaying the 3D movie as illustrated in FIG. 17C.

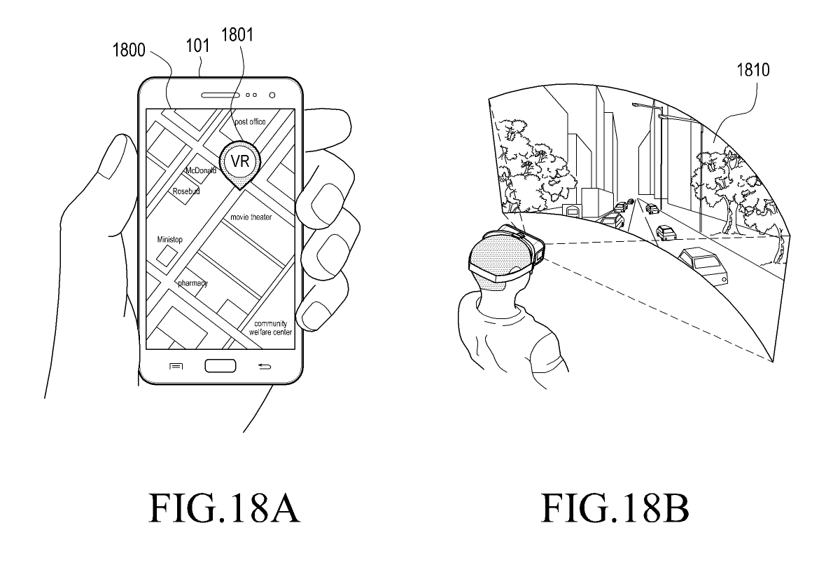

FIGS. 18A, 18B, FIGS. 19A, 19B, FIGS. 20A and 20B are diagrams illustrating examples describing a process of displaying content of a virtual reality format for content according to a content display method according to various example embodiments.

Referring to FIGS. 18A and 18B, the electronic device 101 (for example, the processor 120) may display an icon 1801 for providing a virtual reality content for a point of interest (POI) of the user on an execution screen 1800 of a map application as illustrated in FIG. 18A. When the displayed icon 1801 is selected, the electronic device 101 (for example, the processor 120) may display a 3D map 1810 for the POI as illustrated in FIG. 18B.

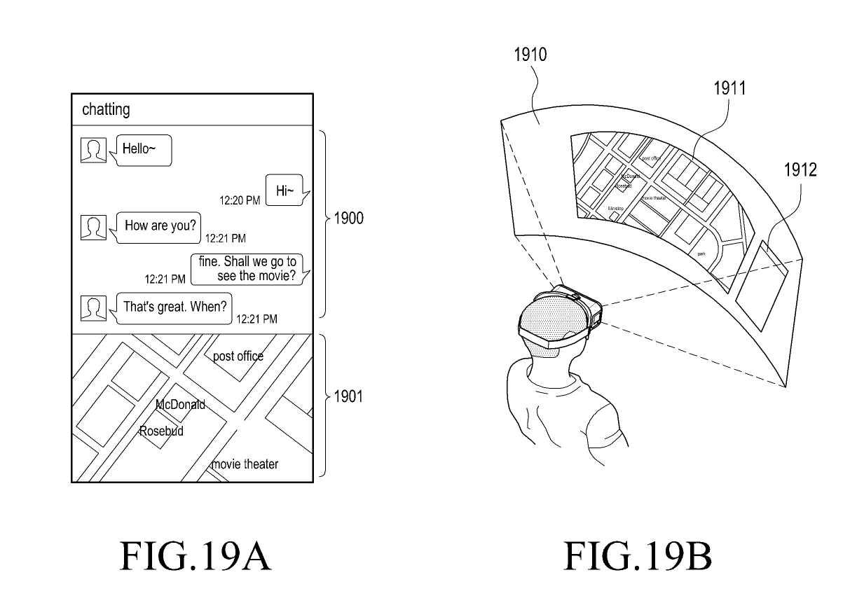

Referring to FIGS. 19A and 19B, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may simultaneously display an execution screen 1900 for a chatting application and an execution screen 1901 for a map application as illustrated in FIG. 19A. When an event for providing a virtual reality content for the currently executed chatting application and map application is detected, the electronic device 101 (for example, the processor 120) may show the execution screen 1901 for the map application in a partial area 1911 within a virtual space, generate a virtual reality content for showing the execution screen 1900 for the chatting application in another partial area 1912, and display a reproduction screen 1910 by reproducing the generated virtual reality content as illustrated in FIG. 19B.

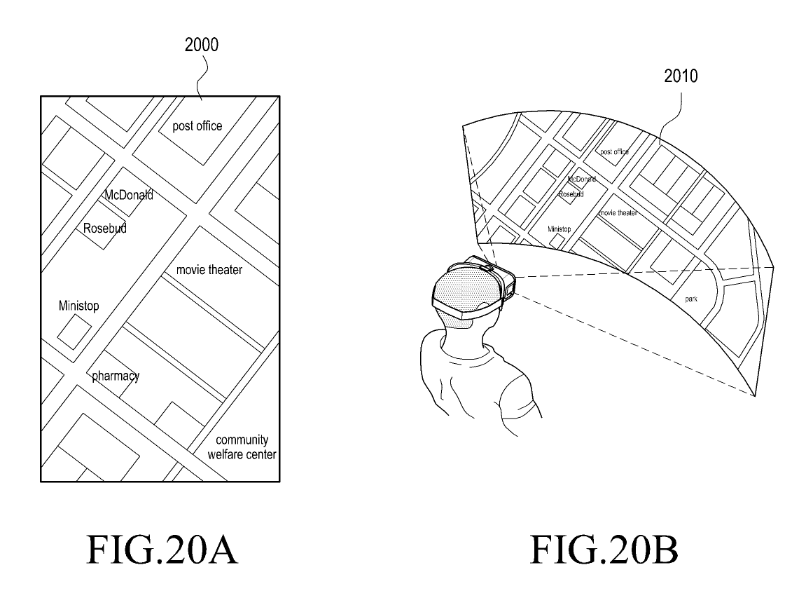

Referring to FIGS. 20A and 20B, when a virtual reality mode is activated while an execution screen 2000 of a map application is displayed as illustrated in FIG. 20A, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may display a 2D map 2010 in an extended window size corresponding to the 2D map as illustrated in FIG. 20B.

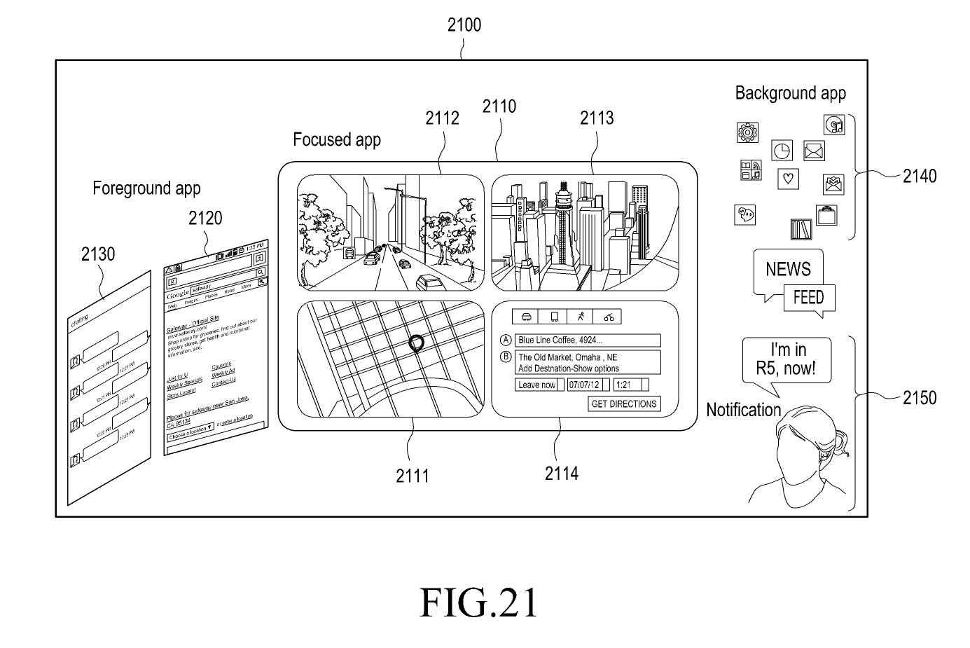

FIG. 21 is a diagram illustrating an example describing a process of displaying content of a virtual reality format when a multitasking function is performed according to various example embodiments.

Referring to FIG. 21, when a plurality of foreground applications according to a multitasking function are executed, a plurality of background applications are executed, and a virtual reality mode is activated, the electronic device 101 (for example, the electronic device 101, 104, or 201, the server 106, the first electronic device 400, the third electronic device 500, or the processor 120 or 210 (the program module 310, the VR application 385, the graphic manager 351, or the VR manager 353)) may generate a virtual reality content that shows an execution screen for a first foreground application in a first area 2110 within a virtual space and shows execution screens of the other executed foreground applications except for the first foreground application in a second area 2120 and a third area 2130, and display a reproduction screen 2100 by reproducing the generated virtual reality content.

For example, when the first foreground application is a map application that provides a 2D map, the first area 2110 may include a first sub area 2111 for displaying the 2D map, a second sub area 2112 for displaying a street view type map related to the 2D map, a third sub area 2113 for displaying a aerial view type map, and a fourth sub area 2114 for displaying traffic information of a particular location.

According to various embodiments, the reproduction screen 2100 may include a fourth area 2140 including floating icons for a plurality of executed background applications.

According to various embodiments, the reproduction screen 2100 may include a fifth area 2150 for displaying notification information. For example, when a notification relay application is executed, the reproduction screen 2100 may include the fifth area 2150 for displaying notification information received from an external electronic device.

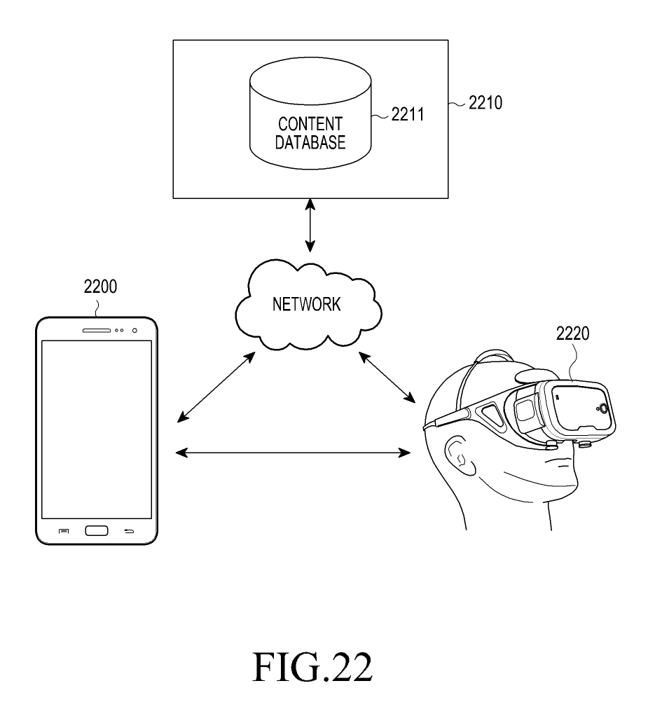

FIG. 22 is a diagram illustrating an example describing a process for displaying content of a virtual reality format in a system including a first electronic device, a second electronic device, and a server according to various example embodiments.

Referring to FIG. 22, the system according to an embodiment of the present disclosure may include a first electronic device 2200, a server 2210, and a second electronic device 2220, each of which may be interconnected via a network.

According to an embodiment, when activation of a virtual reality mode is detected, the first electronic device 2200 may make a request for an attribute of a provided content to the server 2210.

The server 2210 may include a content database 2211 storing contents and attributes of the contents, and identify an attribute of the content requested from the first electronic device 2200. The server 2210 may transfer the identified attribute to the first electronic device 2200.

The first electronic device 2200 may generate a virtual reality content based on the received attribute or the first electronic device 2200 and transfer the virtual reality content to the second electronic device 2220.

The second electronic device 2220 may reproduce and display the received virtual reality content.

According to various embodiments, when the first electronic device 2200 is mounted to the second electronic device 2220, the virtual reality mode is activated, and the first electronic device 2200 may make a request for the attribute of the content to the server 2210, generate the virtual reality content based on the attribute received from the server 2210, and reproduce and display the generated virtual reality content.

According to an embodiment, when the virtual reality mode is activated by the connection between the first electronic device 2200 and the second electronic device 2220, a request for the attribute of the provided content is transmitted to the server 2210 and the server 2210 may transfer the identified attribute to the second electronic device 2220. The second electronic device 2220 may generate content of a virtual reality format based on the received attribute, and reproduce and display the generated content of the virtual reality format.

As described above, according to various embodiments of the present disclosure, the electronic device may conveniently provide content of a virtual reality format for a provided content according to activation of a virtual reality mode.

According to various embodiments of the present disclosure, the user may receive a seamless and immersive virtual reality environment of a provided content.

The term “module” as used herein may, for example, refer to a unit including one of hardware (e.g., circuitry), software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of processing circuitry, an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various example embodiments of the present disclosure may be executed sequentially, in parallel, repeatedly, or in a heuristic manner. Further, some operations may be executed according to another order or may be omitted, or other operations may be added.

It will be understood that the various example embodiments disclosed and described herein are provided to aid in understanding and are intended to be illustrative and not limiting. Those skilled in the art will understand and appreciate that various modifications may be made without departing from the true spirit and full scope of the disclosure a set forth in the appended claims.

What is claimed is:

1. A method of operating an electronic device including a processor, the method comprising:
identifying, by the electronic device, an attribute of content of a 2D format to be provided by an electronic device;
providing a first content of a first virtual reality format corresponding to the content using the processor when the attribute is a first attribute; and
providing a second content of a second virtual reality format corresponding to the content using the processor when the attribute is a second attribute.

2. The method of claim 1, wherein the identifying of the attribute is performed when the electronic device is in a virtual reality mode.

3. The method of claim 2, wherein the identifying of the attribute comprises determining that the electronic device is in the virtual reality mode at least partially based on a functional connection between the electronic device and an external electronic device, the external electronic device including a display device.

4. The method of claim 2, wherein the identifying of the attribute comprises determining that the electronic device is in the virtual reality mode at least partially based on the use of an external electronic device, which is functionally connected to the electronic device and is configured to be wearable on a head of a user.

5. The method of claim 2, wherein the identifying of the attribute is performed at least partially based on an input corresponding to the virtual reality mode.

6. The method of claim 1, further comprising displaying the content in the 2D format through a display functionally connected to the electronic device before the identifying of the content.

7. The method of claim 1, wherein the providing of the first content or the second content comprises:
identifying an object included in the content; and
determining a virtual reality content corresponding to the object as at least a part of a corresponding content between the first content and the second content.

8. The method of claim 1, wherein the providing of the first content or the second content comprises changing the 2D format of the content into a corresponding virtual reality format of the first virtual reality format or the second virtual reality format.

9. The method of claim 1, wherein the providing of the first content or the second content comprises, when the electronic device provides another content, providing a third content of a third virtual reality format corresponding to the other content at least temporarily simultaneously with a corresponding content of the first content or the second content.

10. An electronic device comprising:
a memory configured to store content of a 2D format; and
a processor,
wherein the processor is configured to identify an attribute or situation information of the content of the 2D format to be provided by the electronic device, to provide a first content of a first virtual reality format corresponding to the content when the attribute or the situation information is a first attribute or first situation information, and to provide a second content of a second virtual reality format corresponding to the content when the attribute or the situation information is a second attribute or second situation information.

11. The electronic device of claim 10, wherein the processor is configured to identify the attribute or the situation information of the content of the 2D format when the electronic device is in a virtual reality mode.

12. The electronic device of claim 11, wherein the processor is configured to determine that the electronic device is in the virtual reality mode at least partially based on a communication connection between the electronic device and an external electronic device, the external electronic device including a display device.

13. The electronic device of claim 11, wherein the processor is configured to determine that the electronic device is in the virtual reality mode at least partially based on an external electronic device configured to be worn on a head of a user, the external electronic device being functionally connected to the electronic device.

14. The electronic device of claim 10, wherein, the processor is configured to identify an object included in the content and to determine a virtual reality content corresponding to the object as at least a part of a corresponding content of the first content or the second content.

15. The electronic device of claim 10, wherein, the processor is configured to provide a third content of a third virtual reality format corresponding to another content at least temporarily simultaneously with a corresponding content of the first content or the second content when the electronic device provides another content.

16. The electronic device of claim 10, wherein, the processor is configured to provide a corresponding content of the first content and the second content through a display included in an external electronic device functionally connected to the electronic device.

17. A computer-readable recording medium having instructions stored therein and a program recorded therein which, when executed by a processor, cause the processor to perform operations, the operations comprising:
identifying an attribute of content of a 2D format to be provided by an electronic device;
providing a first content of a first virtual reality format corresponding to the content when the attribute is a first attribute; and
providing a second content of a second virtual reality format corresponding to the content when the attribute is a second attribute.

18. A method of operating an electronic device, the method comprising:
identifying whether an event for providing content of a virtual reality format is detected;
identifying an attribute or situation information of content of a 2D format provided by the electronic device when the event is detected;
determining a content display method of the content of the 2D format based on the identified attribute or situation information; and
providing content of a virtual reality format corresponding to the content of the 2D format based on the determined content display method.

19. The method of claim 18, wherein the content display method includes at least one of a first display method of reproducing and displaying the content of the virtual reality format corresponding to the content of the 2D format, a second display method of combining the content of the virtual reality format with an additional content included in the content of the 2D format and displaying the combined content, a third display method of generating and displaying a virtual reality content that shows the content of the 2D format within a virtual space, a fourth display method of executing and displaying an application that provides a virtual reality service for the content of the 2D format, and a fifth method of extending and displaying a window size or a screen size in which the content of the 2D format is displayed.

20. The method of claim 18, wherein the identifying of the attribute or situation information of the content of the 2D format or the situation information comprises:
acquiring content information of the content of the 2D format when the event is detected; and
identifying the attribute or the situation information related to displaying the content of the 2D format based on the acquired content information.
